(19) United States
(12) Patent Application Publication
(10) Pub. No.: US 2011/0306023 A1
(43) Pub. Date: Dec. 15, 2011

(54) ONLINE LITERACY SYSTEM

(76) Inventors: Marion S. Blank, Victoria (CA); Jonathan Blank, Victoria (CA)

(21) Appl. No.: 12/815,296

(22) Filed: Jun. 14, 2010

(51) Int. Cl. G09B 17/00

(52) U.S. Cl. 434/178

(57) ABSTRACT

In some embodiments, an online literacy system teaches one or all of the skills associated with competence in literacy, including total competence in reading, writing, and punctuation. The system may include a section where the parent or teacher signs up and creates a user account. The system may also include an adult-mediated keyboard and mouse section that is designed to help children learn how to use the keyboard and mouse. The system may also include a skills survey section to continually assess a child's reading and writing skills. The system may also include a pre-reading section that includes exercises selected from a group consisting of sequencing exercises and letter writing exercises using a keyboard. The system may also include a reading/writing skills section that includes reading/writing exercises viewable on a display apparatus to collectively teach all four of the language skills of phonology, semantics, syntax, and text.

### CROSS-REFERENCE TO RELATED APPLICATION

This application is related to U.S. patent application Ser. No. 11/581,894 entitled “Literacy System,” filed on Oct. 17, 2007, which is a continuation of U.S. patent application Ser. No. 10/350,849 entitled “Literacy System,” filed on Jan. 24, 2003, and which claims priority to U.S. Provisional Application Ser. No. 60/362,749 entitled “Literacy System,” filed on Mar. 7, 2002. The complete disclosures of these previous applications are herein incorporated by reference in their entirety.

### TECHNICAL FIELD

This document relates to a system of online literacy education, including methods and systems for teaching reading and writing skills.

### BACKGROUND

Literacy is a skill often taken for granted even though mastery of that skill eludes millions of people from all age groups. For those that are literate, an intricate set of skills enable reading and writing to be smooth and automatic processes. This set of skills, referred to as “hidden abilities,” generally appear first at a young age when a person begins to comprehend the speech of others and when that person begins to speak. For example, even a young child may know that the statement “I am looking at she” is incorrect while the statement “I am looking at her” is proper. Generally, any individual does not know the technical reason behind the proper version, but instead, may offer the rationale that “It just sounds right.” (The technical reason is that when a pronoun referring to a feminine individual is used as the object of a preposition, the correct form of the pronoun is “her,” not “she.”) This example illustrates the essence of the hidden abilities that allow a speaker to do amazingly intricate constructions with language without knowing why. These same abilities are constantly operating in written language as well. For example, in a sentence such as “The soldier decided to desert in the desert,” a skilled reader automatically uses different pronunciations for the two instances of the identically spelled word. For people who are not literate, and especially for young children, these hidden abilities must be developed via literacy education. However, modern systems for teaching literacy fail to address the full range of necessary skills to promote the development of hidden abilities.

In general, two major systems dominate the literacy education field: phonics and whole language. Phonics emphasizes the skill of converting the letters on a page into sounds that become real words (i.e., teaching children to read a word by “sounding out” each letter so that c-a-t becomes “cat”). The processing of sounds falls under a language category known as phonology. The phonics system seems logical because phonology is a significant element in reading, but in practice, phonics teaching is hindered by the complexities of the English language. Phonics relies on teaching that each letter makes a single, distinctive sound. The reality, however, is that this concept holds true for only a tiny fraction of English words. Indeed, of the seventeen words in the preceding sentence, not a single one meets this criterion. The problem is illustrated by the fact that, under the phonics system of teaching, the word “phonics” itself should be spelled “foniks.” To overcome this problem, the system relies on children memorizing hundreds of rules, such as the “silent e” rule, the double vowel rule, and the consonant combination rules. The memorization of these rules and “sounding out” individual letters causes many to experience reading and writing as a laborious process, leading to discouragement and failure. The whole language system of teaching literacy focuses on complete stories (i.e., the meaningful messages of long complex sequences of words). This is different than the dissection of individual words that is the hallmark of phonics. However, it leads many children in the early stages of reading to encounter a wider range of words than they are capable of reading which is often overwhelming to the student.

The prevailing assumption is that these two systems, in combination, address all of the skills necessary to literacy. Unfortunately, these two systems, alone or in combination, cover only a portion of the skills that reading requires. The skills that are not addressed by these systems leave gaps in the literacy education that only a certain percentage of students are able to overcome. For those students who are not able to overcome the gaps of the current literacy systems, reading and writing may become a frustrating activity that is to be avoided.

Among the components needed for an effective literacy system are ones that develop the pre-reading skills of visual sequencing and fine motor abilities. In addition, other components needed for an effective literacy system are ones that collectively teach all four of the language skills of phonology, semantics, syntax, and text.

### SUMMARY

In some embodiments, an online literacy system teaches one or all of the skills associated with competence in literacy, including total competence in reading, writing, and punctuation. The system may include a section where the parent or teacher signs up and creates a user account. The system may also include an adult-mediated keyboard and mouse section that is designed to help children learn how to use the keyboard and mouse. The system may also include a skills survey section to continually assess a child's reading and writing skills. The system may also include a pre-reading section that includes exercises selected from a group consisting of sequencing exercises and letter writing exercises using a keyboard. The system may also include a reading/writing skills section that includes reading/writing exercises viewable on a display apparatus to collectively teach all four of the language skills of phonology, semantics, syntax, and text. The reading/writing skills section may include a plurality of levels of exercises that introduce sets of content words and non-content words in a combination of exercises to collectively teach all four of the language skills of phonology, semantics, syntax, and text. The five levels of exercises may include a plurality of books in each level that are restricted to words that the children have been taught.

In certain implementations, an online literacy system may be automated and require minimal adult supervision. The system may also provide continuous assessment and customization. The system may also reinforce left to right sequencing. The system may also provide automatic correction of error. The system may also teach language in a systematic manner. The system may also provide feedback and progress reports to parents. The system may also skip material the child already knows. The system may also emphasize meaning and comprehension. The system may also use sound to support the link between written and spoken language. The system may also be flexible and customizable. The system may also teach punctuation. The system may also teach the use of a keyboard and mouse. The system may also force writing from memory. The system may also provide fun and entertainment for children.

The literacy system of various embodiments teaches writing in numerous ways. The system may teach language skills that are necessary for writing. The system may teach learning to read, which will assist the child in learning to write. (In turn, learning to write will assist the child in learning to read.) The system may also teach writing through various formats/games that teach and reinforce writing. For example, in various formats/games, the child may be asked to type in words, which teaches and simulates writing.

In selected embodiments, a series of exercise levels and story books in an online literacy system can collectively teach all four of the language skills of phonology, semantics, syntax, and text. Each exercise level may include sets of reading/writing skills exercises introducing a targeted set of content words and non-content words. Each exercise level may be followed by a plurality of associated story books. Each story book may include a plurality of pages with text that provides a story and with one or more images related to the story. The text of each story book may consist only of those content words and non-content words that were introduced by earlier exercises. This way, the reader of the story book is exposed only to those content words and non-content words that were previously introduced with the reading/writing skills exercises of the earlier exercises.

An online literacy system may include an assessment system in certain implementations. Before children are taught any content word, the system may give them a skills assessment to determine if they already know that word. If they do, they skip the teaching of that word. If the child does not know the word, they are taught the word via the system's reading/writing exercises. For the teaching of any new word, children see text and exercises containing the target word plus any words previously taught. A child is never expected to handle a word that has not been taught. Children may continue learning all the words and books of a level. Once they have finished a level, children may be given an assessment to determine if they learned the reading and writing skills from that level satisfactorily. If they have not, they may be given a review that ensures their learning is satisfactory. If the assessment section determines that their learning was satisfactory, they may move on to the next level. Children may continue through the program in this fashion until they have completed the entire program.

In some configurations, an online literacy system may include multimedia. The system may include animation and artwork, and music and sound effects. The system may allow children to hear the words, so the link between spoken and written language is more direct and clear. The system may allow children to hear the books and stories read aloud, and allow children to control whether a book or story is read aloud. The system may use graphics to teach the meaning of language and present graphics in ways to make children think about language.

An online system for teaching skills associated with literacy may be automated and allow children to use the system on their own with minimal adult supervision in various implementations. Audio may be consistently available so a child can click on any word and hear it spoken, which may bypass the failure that can occur with print material when a child cannot decode a word. The system may include a feedback system that provides feedback to the teacher or parent about the child's performance.

The details of one or more embodiments of the invention are set forth in the accompanying drawings and the description below. Other features, objects, and advantages of the invention will be apparent from the description and drawings.

### DESCRIPTION OF DRAWINGS

FIG. 1 is a flow chart of instructions in accordance with one embodiment of the invention.

FIG. 2 is a diagram depicting aspects of one embodiment of an online literacy system in accordance with the invention.

FIG. 3 is a swim lane diagram of the online literacy system depicted in FIG. 2.

FIG. 4 is a chart of teaching formats in accordance with one embodiment of the invention.

FIG. 5 is a chart of data structures in accordance with one embodiment of the invention.

FIG. 6 is a diagram of a computer system that may be used to operate the online literacy system in accordance with one embodiment of the invention.

FIG. 7 depicts a skills survey in accordance with one embodiment of the invention.

FIG. 8 depicts an example of a teaching format in accordance with one embodiment of the invention.

FIGS. 9A-9C depict examples of teaching language in accordance with one embodiment of the invention.

FIG. 10 depicts an example of a teaching format in accordance with one embodiment of the invention.

FIG. 11 depicts a progress report in accordance with one embodiment of the invention.

FIG. 12 depicts an example of a teaching format in accordance with one embodiment of the invention.

FIG. 13 depicts an example of a teaching format in accordance with one embodiment of the invention.

FIG. 14 depicts a story book in accordance with one embodiment of the invention.

FIG. 15 depicts an example of a teaching format in accordance with one embodiment of the invention.

FIG. 16 depicts an example of a teaching format in accordance with one embodiment of the invention.

FIGS. 17A-P depict examples of teaching formats, assessment exercises, and review exercises in accordance with one embodiment of the invention.

FIGS. 18A-G depict examples of story books in accordance with one embodiment of the invention.

Like reference symbols in the various drawings indicate like elements.

### DETAILED DESCRIPTION

Certain embodiments of the literacy system described herein teach one or all of the following skills associated with total competence in literacy, including total competence in reading, writing, and punctuation:

(1) sequencing—the ability to read, and retain, letters in the appropriate order,

(1) motor skills—the hand-eye coordination required for writing,

(3) phonology—the ability to recognize and produce the sounds of letters,

(4) semantics—comprehension of the meaning of words,

(5) syntax—the ability to recognize and use grammar, and

(6) text—combining words to form meaningful messages.

Sequencing and motor skills are both types of physical skills associated with reading and writing, as described later in more detail. Briefly, visual sequencing exercises may be used to teach left-to-right scanning and memorization of symbols, letters, and words. Motor skills exercises may be used to develop handwriting abilities in a student such that subsequent reading and writing skills may be taught in tandem.

Phonology is a language skill relating to the processing of the sounds used in forming the words of a language. In reading, the sounds are represented by letters and letter combinations. For example, a literate reader may know that “ph” has the sound of “f” in certain instances (i.e. elephant), but not in other instances (i.e. uphill is not pronounced as “ufill” and shepherd is not pronounced as “shepherd”). The skill of recognizing the proper sounds of letter combinations falls under the category of phonology.

Semantics is another language skill and is associated with the meaning of words. For example, in the statement “the girl did not hear the band,” the word band refers to a group of musicians, while the word band in the sentence “the girl did not wear the band” refers to a piece of jewelry that can be put on one's body. The skill of phonology may be used to show that the pronunciation of “band” and “band” are identical, but the language skill of semantics enables a student to recognize the different meanings.

The language skill relating to the grammar of sentences is referred to as syntax. One example of a syntax skill is the proper usage of the words “they're,” “there,” and “their” in a sentence such as “they're there at their house.” In another example, the word “read” may be pronounced as “red” or “reed” depending upon the grammatical construction of the sentence (i.e. “yesterday, they read the magazine,” or “usually, they read the magazine”).

Lastly, the language skill of text is associated with the ability to use combinations of words and sentences to form meaningful messages. In the early stages of learning to read, a student may be able to read only several words, and those words may not be combined so as to form a statement or sentence. As that student learns to read additional words, that student must also develop textual skills of combining those words in the appropriate order in order to express a desired message.

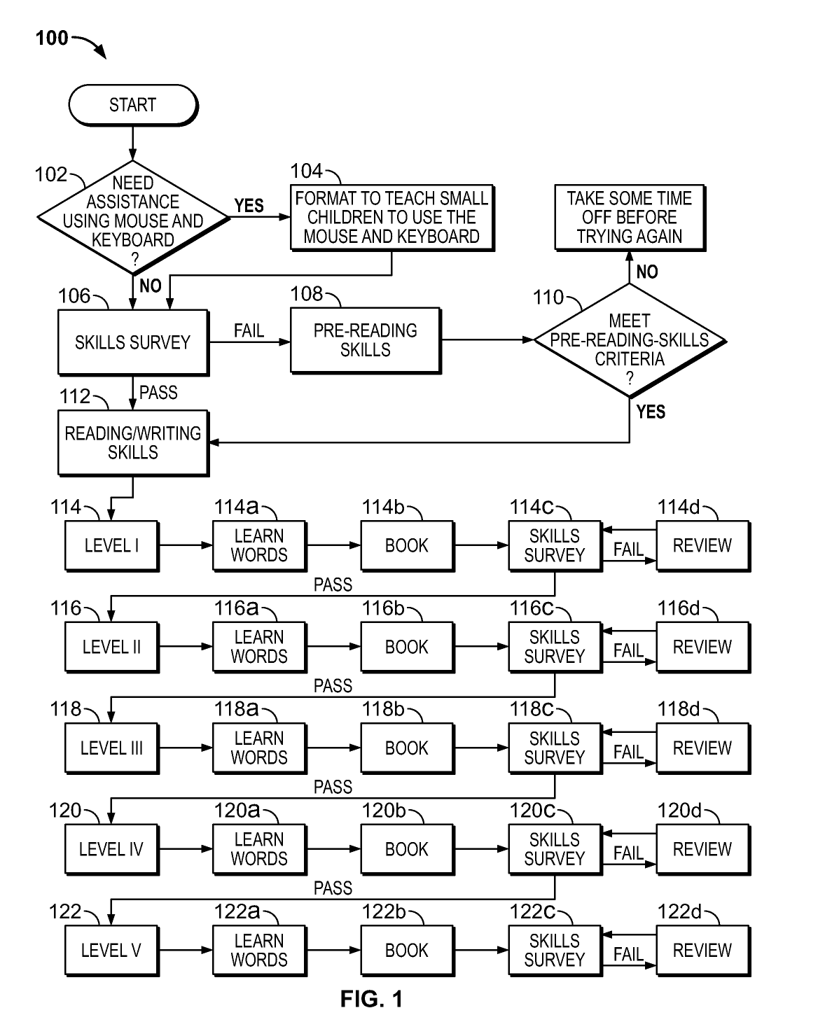

In one embodiment of the invention, as shown in FIG. 1, an online literacy system may have the following program flow 100. The parent or teacher may sign up and create the user account. The parent or teacher may begin the teaching program with the child. The user may be given the choice to either begin the program immediately, or if assistance with using the keyboard and mouse is required (102), the user may use a special adult-mediated format designed to help children learn how to use the keyboard and mouse (104). If the user chooses to do the format for teaching the keyboard and mouse (104), program may begin once the user has completed it.

As shown in FIG. 1, once the child begins the actual program, the program may begin with a skills survey (106). The skills survey may assess a child's current reading and writing skills. The skills survey may allow the child to enter the program at the precise level required. This may prevent a child from wasting time learning something they already know (which may lead to boredom) or being taught skills that the child is not yet ready for (which may create anxiety and failure). The online literacy system may be customized to each child and ensure that they are only learning what they need and are ready to learn.

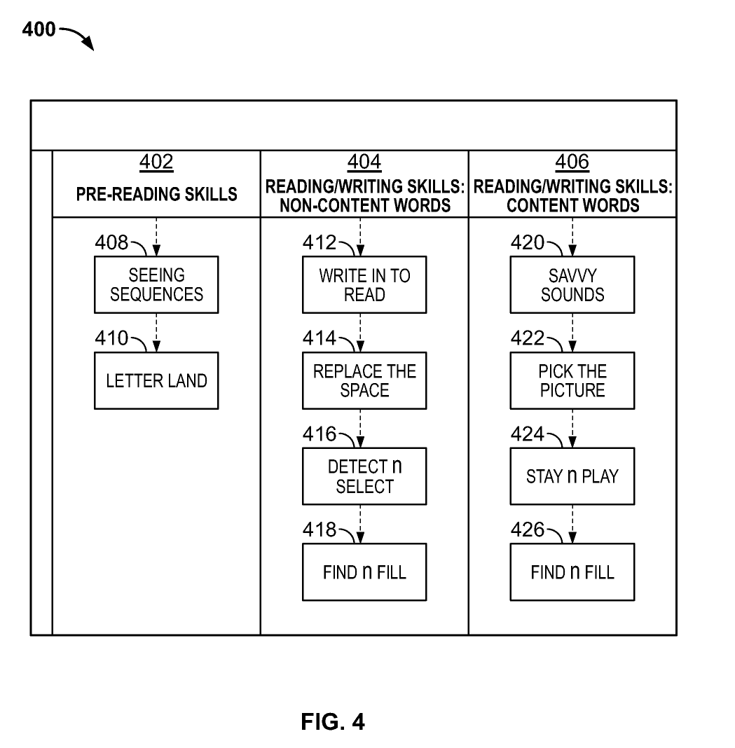

As shown in FIG. 1, once the skills survey is completed, the child may begin the program. The program may be divided into two basic areas: pre-reading skills (108) and reading/writing skills (112). If the skills survey (106) has determined that a child needs to begin with the pre-reading skills, the child may start off with one or both of the two pre-reading formats: Seeing Sequences 408 and Letter Land 410 (FIG. 4). These pre-reading formats will be discussed in further detail below. Next, if the skills survey determined that a child does not need to do the pre-reading skills, or the child has completed the pre-reading skills, the child may begin the reading/writing skills of the program which may be divided into a plurality of levels (112). The reading/writing skills of the program may be divided into any number of levels (114-122) without departing from the invention.

The reading/writing skills words may be divided into two categories: non-content words and content words (114a, 116a, 118a, 120a, or 122a). These types of words will be discussed in further detail below. Before a child is taught any content word, the child may be given a very brief skills assessment to determine if they already know that word. If the child knows the word, the child may skip the teaching of that word. This is part of the system's customization features. If the child does not know the word, they may be taught the word via one of the system's teaching formats. For the teaching of any new word, the child may see text and exercises containing the new target word plus any words previously taught. The child may never be expected to handle a word that has not been previously taught.

As shown in FIG. 1, once a child has learned all the words of a book using the various formats, the child may be given a book (114b, 116b, 118b, 120b, or 122b) to read. The books may have numerous features. The books may be restricted to words the children have been taught. In addition, the sentences of the early books may start with basic phrases (e.g., “some kids”) and simple sentences (e.g. “Here is a kid.”). The books may then systematically increase the complexity of the sentences so that they begin to cover past tense (“the cats were playing”), complex sentences (“the boy can jump, but he is not jumping”) and other advanced formulations of English syntax. In addition, the odd books may be presented as traditional books which children can choose to read on their own or have read to them. The even books may ask children to fill in words. Filling in words may give children an active role in creating the stories which gets them more involved and helps ensure that they understand what they read. In addition, the different levels of the books may teach different genres of text (e.g., for example one level may teach the basics of science texts, another level may teach the basics of narrative, etc.). In addition, the advanced books may include another format, Gleaning Meaning. The format Gleaning Meaning may teach comprehension and help to ensure that child learns the skill of understanding and being able to relate the “main idea” of a story.

As shown in FIG. 1, a child may continue learning all the words and books of a level. Once the child has finished a level, the child may be given a progress check (assessment) to determine if the child has learned the reading and writing skills from that level satisfactorily. If the child has not, the child may be given a review 114d, 116d, 118d, 120d, or 122d) (with similar teaching formats but with new content) that ensures that the child's learning is satisfactory. If the skills survey (114c, 116c, 118c, 120c, or 122c) determines that the child's learning was satisfactory, the child may move on to the next level. The child may continue through the program in this fashion until the child has completed the entire program.

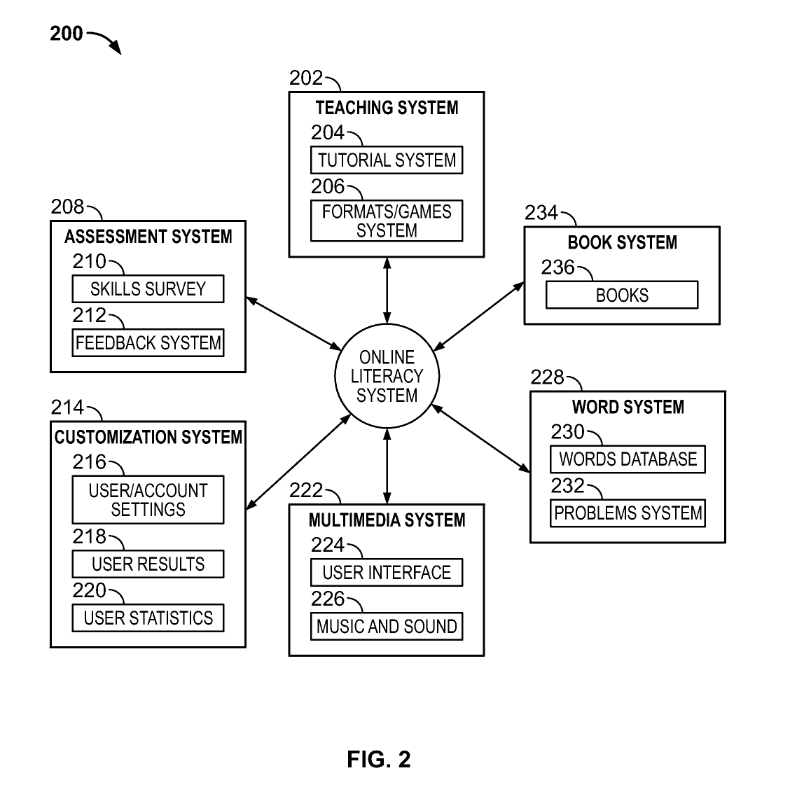

FIG. 2 depicts aspects of an online literacy system 200 in accordance with one embodiment of the invention. As shown in FIG. 2, the online literacy system 200 may be divided into a plurality of modules each responsible for an aspect of the online literacy system 200. The modules may include a teaching system 202, an assessment system 208, a customization system 214, a multimedia system 222, a word system 228, and a book system 234.

As shown in FIG. 2 the online literacy system 200 may include a teaching system 202. The teaching system 202 may include a tutorial system 204 and formats/games system 206. The tutorial system 204 may be responsible for teaching various aspects of the online literacy system, such as the adult-mediated keyboard and mouse tutorial, pre-reading skills, and reading/writing skills. The tutorial system 204 may contain implementation and functionality for teaching how to use a keyboard and mouse, pre-reading skills, and reading/writing skills. The formats/games system 206 may be responsible for organizing and managing the various teaching formats/games. The formats/games system 206 may contain implementation and functionality for Seeing Sequences 408, Letter Land 410, Write in to Read 412, Replace the Space 414, Detect n Select 416, Find n Fill 418, 426, Savvy Sounds 420, Pick the Picture 422, and Stay n Play 424. The formats/games system 206 may be closely integrated with the tutorial system 204, as the tutorial system 204 may use formats/games 206 to teach pre-reading skills and reading/writing skills.

As shown in FIG. 2 the online literacy system 200 may include an assessment system 208. The functionality of the assessment system 208 has been discussed above. The assessment system 208 may include a skills survey 210 and feedback system 212. The skills survey 210 may include additional systems such as a word assessment and a review system. The word assessment system may operate such that before a child is taught a content word, they are given a skills assessment to determine if they already know that word. If they do, they may skip the teaching of that word. The review system may operate after a child has finished a level if the skills survey indicates that the child has not learned the reading and writing skills satisfactorily. If they have not, they may be given a review (with similar teaching formats but new content) that ensures their learning is satisfactory. If the skills survey 210 determines that their learning was satisfactory, they may move on to the next level. As discussed above, the skills system 210 may assess the child before the child begins reading/writing skills and assesses the child before the child moves on to the next level of reading/writing skills.

The feedback system 212 may include a progress check system and parent/teacher feedback/report system. The progress check system may generate occasional progress reports (for example every week or every time a child finishes a level) and may allow the adult to stay informed of the child's progress. Adults may receive regular e-mail updates of progress reports or the progress reports may be displayed on the adults section of the system's website. More generally, the adult feedback/report system may contain the implementation and functionality of providing any type of feedback or reports to adults.

As shown in FIG. 2 the online literacy system 200 may include a customization system 214. The customization system 214 may include a user/account settings system 216, a user results system 218, and a user statistics system 220. The user/account settings system 216 may contain the implementation and functionality for allowing the reader to create and change the user or account settings. The user or account settings may include functionality for allowing the parent or teacher to initially sign up and create the reader accounts. The user or account settings may also contain many other settings such as settings related to display, sound, password, assessment, feedback, teaching, book, words, etc. The user or account settings may allow the user to customize settings and options for many aspects of the online literacy system.

The user results system 218 may contain the implementation and functionality for maintaining user results. The user results system 218 may store results when the user finishes a word, book, problem, teaching format, or level. The user results system 218 may store results relating to the user's performance and progress. The results system 218 may be used by and in conjunction with other systems (such as the assessment system or teaching system) to provide the user with an effective learning experience. The user statistics system 220 may contain the implementation and functionality for maintaining the user statistics. The user statistics system 220 may store statistics when the user finishes a word, book, problem, teaching format, or level. The user statistics system 220 may also store statistics based on the user's sessions, such as the amount of time the user has used the system in the past week, month, or year. The user statistics system 220 may be used by and in conjunction with other systems (such as the assessment system or teaching system) to provide the user with an effective learning experience. If the statistics indicate that the user has difficulty with a particular aspect of reading or writing, the assessment system and teaching system may ensure that the user receives additional review and skills survey on that aspect.

As shown in FIG. 2 the online literacy system 200 may include a multimedia system 222. The multimedia system 222 may include a user interface system 224 and a music and sound system 226. The user interface system 224 may contain the implementation and functionality of the user's display and input to the online literacy system. The user interface system 224 may control the appearance and style of the online literacy system 200 to the user. The user interface system 224 may allow the user to modify the appearance and style of the online literacy system 200. The user interface system 224 may also receive input (via keyboard or mouse) from the user and send the information to the online literacy system 200. The user interface system 224 may also contain systems for animation and artwork. The animation and artwork may be part of the online literacy system 200, and may make the system 200 more entertaining or similar to a video game. The animation and artwork may also make the system 200 more colorful, add a distinctive visual style, and/or increase visual learning.

The music and sound system 226 may contain the implementation and functionality of the music, sound effects, and recordings of words and books. In addition to animation and artwork, the system 226 may include music and sound effects. The music and sound effects may be part of the online literacy system 200, and may make the system 200 more entertaining or similar to a video game. The music and sound effects may also create distinctive acoustic style and/or increase acoustic learning. The music and sound system 226 may also contain and manage recordings of words and books. These recordings may be played back to the child as the child is going through words and books. Being able to hear words and books may increase learning in children. This may enable children to link the visual and auditory components of words, which may not be available in printed material. In addition, the hearing of the words may allow children to access the pronunciation of any word they do not recall. This may prevent the failure and frustration that may follow failure to decode a word.

The user may have the option to customize or adjust the playback of recordings of words and books, sound effects, and music. The user may have the option to mute the playback of sound effects or music. In addition, the user may be able to control the playback of recordings of words and books through the user interface. For example, hearing the words play may only occur when the user clicks on a word and hearing the books read aloud may only occur when a child chooses to hear a story read to them.

As shown in FIG. 2 the online literacy system 200 may include a word system 228. The word system 228 may contain the implementation and functionality of words. The word system 228 may contain a universal database of words. All of the words of the online literacy system 200 may be stored in a words database 230. Other systems, such as the skills survey 210 or format/games system 206, may interact with the words database 230 to pull words or information about words. The problems system 232 may control the implementation and functionality of each problem. The problems system 232 may control individual problems that the user interacts with as part of the testing/learning process. Each problem may be associated with a single word, and a single word may have a plurality of problems associated with it. Other systems, such as the skills survey 210 or format/games system 206 may interact with the problems system 232 to retrieve problems or information about problems.

As shown in FIG. 2 the online literacy system 200 may include a book system 234. The book system 234 may contain the implementation and functionality of books. For example, the book system 234 may contain a database of all of the books 236. Each book may have its own information, such as the words in the book and the level of the book. In addition, each book may include a plurality of pages with text that provides a story and with one or more images related to the story. The text of each book may consist only of those content words and non-content words that were introduced by earlier exercises.

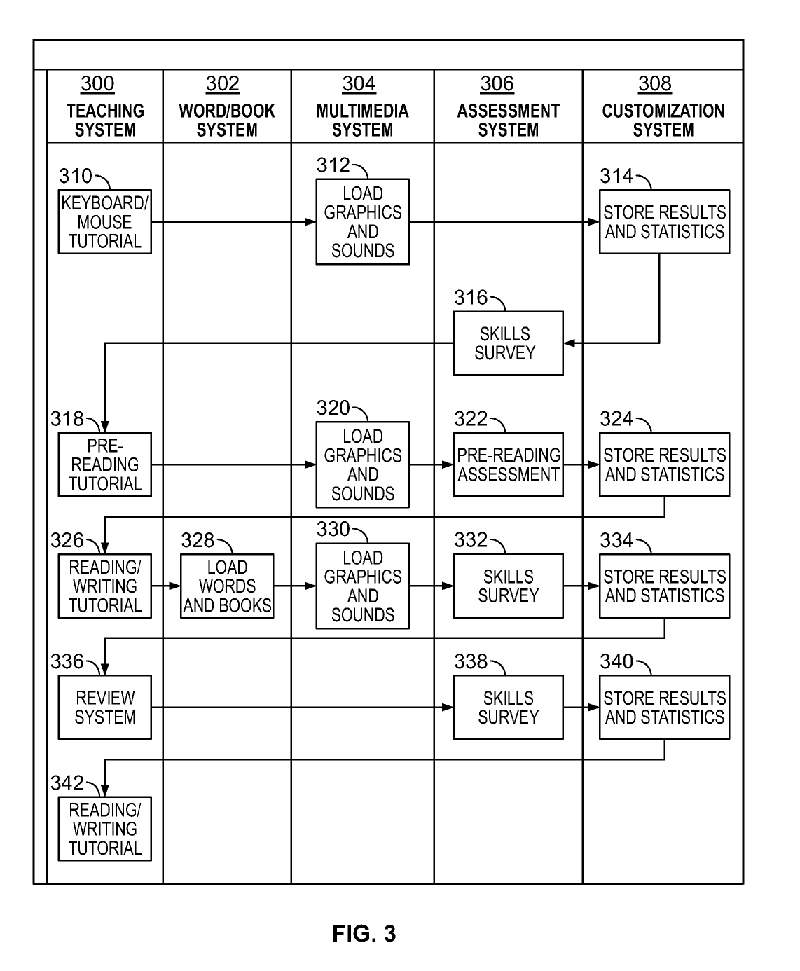

FIG. 3 depicts a swim lane diagram of an example of the online literacy system 200 of FIG. 2. As shown in FIG. 3, the teaching system300, word and book system 302, multimedia system 304, assessment system 306, and customization system 308 may be conceptualized or implemented as separate processes working together. FIG. 3 contains swim lanes arranged horizontally to show the various sub-processes according to the responsibilities of the teaching system 300, word and book system 302, multimedia system 304, assessment system 306, and customization system 308.

For example, as shown in FIG. 3, the teaching system 300 may include the adult-mediated keyboard/mouse tutorial 310. The keyboard/mouse tutorial 310 may be loaded by the teaching system 300, and then the multimedia system 304 may load the graphics and sounds 312. As the user goes through and completes the keyboard and mouse tutorial 310, the results and statistics may be stored 314 as part of the customization system 308.

Further, as shown in FIG. 3, once the user has completed the keyboard and mouse tutorial 310 and the user results and statistics have been stored 314, the user may take a skills survey 316, which may be part of the assessment system 306. Depending on the results of the skills survey 316, the user may begin the pre-reading tutorial 318. Like other tutorials, the pre-reading tutorial 318 may load graphics and sounds 320 from the multimedia system 304. Once the user has completed the pre-reading tutorial 318, the user may begin a pre-reading assessment 322. Throughout the process, the user's results and statistics may be stored 314 in the customization system 308.

Further, as shown in FIG. 3, once the user has completed the pre-reading tutorial 318, the user may begin the reading/writing tutorial 326. The reading/writing tutorial 326 may be the main component of the teaching system 300 and the online literacy system 200. The reading/writing tutorial 326 may contain words and books and interface with the word and book systems 302. For example, the reading/writing tutorial 326 may run queries from the word and book databases and load words and books. The reading/writing tutorial 326 may also load graphics and sounds 312 from the multimedia system 304. Once the user completes one level of the reading/writing tutorial 326, the user may take a skills survey 338. Throughout the process, the user's results and statistics may be stored 314 in the customization system 308.

Further, as shown in FIG. 3, if the user fails the progress check the user may continue to a review system 336, which may also be a part of the teaching system 300. The review system 336 may use similar teaching formats as the reading/writing tutorial 326 but with new content. After the user completes the review system 336, the user may take another skills survey 338 to ensure that learning is satisfactory. Throughout the process, the user's results and statistics 340 (including the results and statistics on the review system) may be stored in the customization system 308. Once the user successfully completes the skills survey 338, the user may proceed to the next level of the reading/writing tutorial 342. The reading/writing tutorial 342 may continue in this fashion until the user has completed the entire program.

FIG. 4 shows the organization of teaching formats 400 in accordance with one embodiment of the invention. The teaching formats 400 may be divided into three categories depending on which skills are taught by the system. The skills may include pre-reading skills 402, non-content words 404 (which is part of reading/writing skills), and content words 406 (which is part of reading/writing skills). The teaching formats may include Seeing Sequences 408, Letter Land 410, Write in to Read 412, Replace the Space 414, Detect n Select 416, Find n Fill 418, 426, Savvy Sounds 420, Pick the Picture 422, and Stay n Play 424. A detailed description of all of the teaching formats is provided below. The teaching formats 400 all teach one or all of the skills associated with competence in literacy, including total competence in reading, writing, and punctuation. For example, some teaching formats may teach the skill of writing. Teaching formats that involve typing in words (such as Letter Land 410, Write in to Read 412, Replace the Space 414, Find n Fill 418, 426, Pick the Picture 422, Stay n Play 424) may teach and reinforce writing.

As shown by FIG. 4, the reading/writing formats 404, 406 are divided into two categories: non-content words 404 and content words 406. The first category is non-content words 404 which are words such as “the,” “is,” “was,” and “they.” The non-content words may be neglected in reading education because they cannot be sounded out and do not have obvious meanings. However, out of the 200 or so non-content words in the entire English language, about 100 of them may occupy an estimated 50% or more of any page of text a person will encounter in their entire lives. The online literacy system 200 may teach these 100 non-content words, which may ensure that children will recognize 50% of every page of text they ever see and have greater understanding of grammar.

The second category of writing/reading formats is content words 406. Content words comprise all the rest of the words in the English language (and include nouns, adjectives, pronouns, verbs and adverbs).

As shown by FIG. 4, the two teaching formats that may teach pre-reading skills 402 are Seeing Sequences 408 and Letter Land 410. The four teaching formats that teach non-content words 404 (reading/writing skills) are Write in to Read 412, Replace the Space 414, Detect n Select 416, and Find n Fill 418. The four teaching formats that teach content words 406 (reading/writing skills) are Savvy Sounds 420, Pick the Picture 422, Stay n Play 424, and Find n Fill 426. The teaching format of Find n Fill 418, 426 is the only format shared by both non-content 404 and content 406 words. This is because accurate spelling is essential to both content and non-content words.

All of the online literacy program formats may offer repeated trials to strengthen the development of the particular skills. The formats may also offer tutoring support for wrong responses, so that the child can learn from their mistakes and get to the correct response.

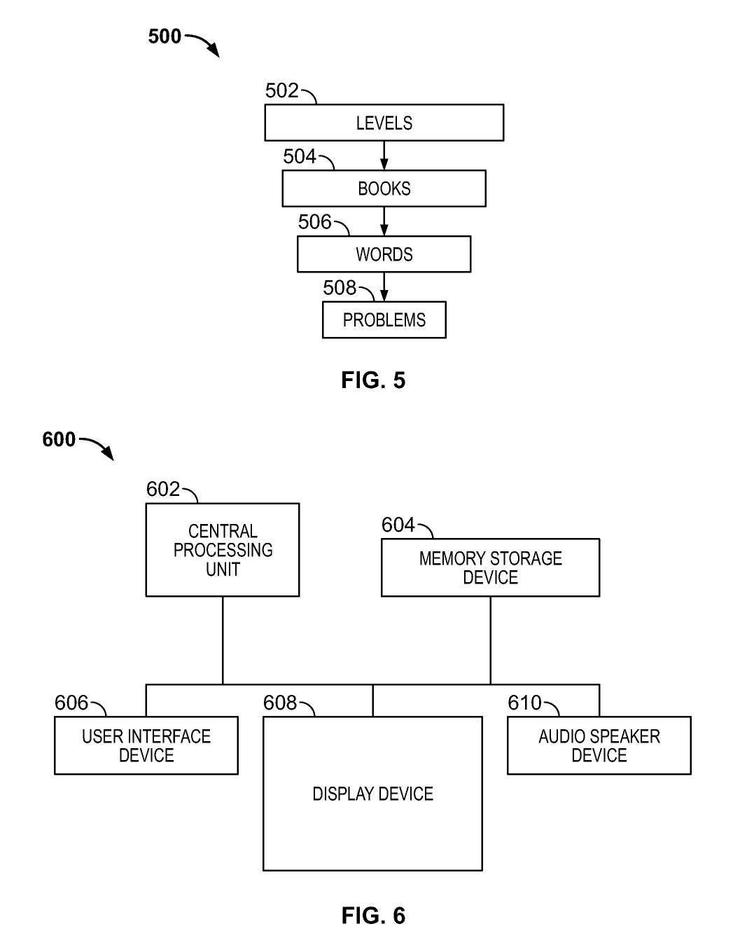

FIG. 5 shows the data structures 500 that may be used as part of the software implementation in accordance with one embodiment of the invention. The curriculum may be divided into several tiers: levels 502, words 504, books 506, and problems 508. Each tier may be nested inside of another. The top tier may be levels 502. The levels table may contain the highest tier of curriculum information. For example, the entire curriculum may fit roughly within seven “levels”: five levels of reading/writing, an assessment, and a mouse/keyboard tutorial.

As shown in FIG. 5, the next tier may be books 504. Each level has a number of books assigned to it. The user may start with a skills assessment, followed by a plurality of books, a progress check, and a review. The various flags set via the database/admin tool may indicate the path to take based on user results.

As shown in FIG. 5, the next tier may be words 506. Any number of words may appear in a book 504. These words may represent the words that must be learned to read the book 504. Words may have certain criteria specified in order to receive a “pass” on the word. This information may be designated in the cumulative pass requirements of a word. Each word may have a number of problems. When the user finishes a problem, a number of variables may be submitted to the results processing package. It may be possible to use variable names alone or added together to specify a requirement to pass the word.

As shown in FIG. 5, the next tier may be problems 508. Problems 508 may be individual files that the reader interacts with as part of the testing/learning process. Users may pass or fail specific problems. It may be possible to specify the variable name/value required to pass, so the user will only pass if the criteria are met. It may also be possible to specify the maximum field values for every variable in each problem. This may assist the algorithm predict ahead of time if a word cannot be passed even if a perfect score is achieved. As the reader begins, passes, or fails levels, books, words, or problems, the results may be stored in a results table.

The teaching of the literacy system 200 may be delivered to the student in the format of interactive website, computer software, or a combination thereof. For example, as shown in FIG. 6, the online literacy system 200 may be used as a computer software such that the student interacts with the computer system 600 to complete some or all of the exercises. In one embodiment, the literacy system 200 may be executable as a software program stored on a computer readable medium in a computer memory storage device 604, such as a computer hard drive, a floppy disk drive, a CD-ROM drive, or other conventional devices. The user may utilize a user interface device 606, such as a keyboard, computer mouse, touchscreen, or a combination thereof, to execute the literacy system 200 from the computer memory storage 604 device using a central processing unit 602. The display device 608 may be used to display the various images, instructions, and exercises of the literacy system. The computer system may include an audio speaker device 610 for delivering audible instructions or feedback to the user. In addition to the computer system 600, a workbook may be used in conjunction with the computer system 600 to provide the student with further instructions and a tangible medium for particular reading and writing exercises.

FIGS. 1-6 provide examples of an online literacy system 200 in accordance with some embodiments of the invention. The examples may contain a number of distinct features. Some of these features may include:

automated and requires minimal adult supervision

continuous assessment and customization

reinforces left to right sequencing

automatic correction of error

teaches language in a systematic manner

feedback and reports to adults

skips material the child already knows

emphasis on meaning and comprehension

uses sound to support link between written and spoken language

flexible and customizable

teaches punctuation

teaches use of keyboard and mouse

forces writing from memory

provides fun and entertainment

In some embodiments, an online literacy system 200 may be automated and require minimal adult supervision. For example, once a child begins using the program and feels comfortable using the program, the child may be able to use the program almost exclusively on their own. The adult may wish to assist the child in using the program for one or two introductory sessions. In these introductory sessions, the adult may emphasize teaching the child how to use the program. But as soon as the child begins to master the program, the child may be able to use the program on their own. Once the child has mastered the program, the program may be automatic and requires little or no adult supervision.

Because of the automated system, children may use the program even if they have busy parents who do not have time to personally supervise their child's education. This may also enable teachers or parents to reduce the time they spend actually teaching reading, while still providing individualized instruction for each child. This may allow more children (including children from different family circumstances) to use the online literacy system. This may also allow parents and teachers to have more time and focus on other aspects of the child's literacy education.

In the automated system, adults may always have access to the parent's section of the online literacy system 200 to keep updated on the child's progress. Adults may also receive regular updates or progress reports via e-mail. This may allow adults to closely monitor and gauge the child's progress, even if the adult is not personally supervising the child's education. In some ways, the parent may obtain more information (and more accurate information) about the child's progress than if the adult were directly observing the child using the program. This is because the feedback and progress reports the adults receive summarize and synthesize the child's progress. Adults may quickly see the “big picture” and understand areas of improvement and weakness of a child, which may not be apparent if the adult supervises the child using the program in isolated sessions.

An online literacy system 200 may be automated and configured to require minimal adult supervision. The child may be presented with static computer pages or static website pages. The system 200 may be configured to prohibit skipping to a different and incorrect part of the program. Instead the child may be instructed to follow a linear program flow. The system 200 may also include a help button or resource. The help button or resource is something the child can use if they get stuck with the program and are not sure how to proceed. The help button or resource will tell the child exactly what they need to do to continue to program such as “Click on the green arrow” or “Answer the question.”

Related to the help button or resource, the online literacy system 200 may include a hint feature for when the child becomes stuck on answering a problem. The hint feature is different than the help feature. The help feature may be aimed at helping the child overcome technical problems, such as continuing to the next page or closing the current/game format. The hint feature may be aimed at helping with child substantive literacy problems, such as if the child is stuck on a particular problem or word. The hint feature may attempt to help the child solve the current problem or word without just providing the solution. The hint feature may not reduce the educational value of having the child solve the problem or word. At the same time, the hint feature will prevent the child from becoming stuck and having to stop using the program or to find an adult for additional support or supervision.

These features and other features may help the online literacy system 200 to become automated and to require minimal adult supervision. The automated and requiring minimal adult supervision aspects of the online literacy system are illustrated by all of the figures below.

In some embodiments, an online literacy system 200 for teaching skills associated with literacy may provide continuous assessment and customization. For example, after completing a level of the program, the online literacy system 200 may assess the child's skills to determine if they have learned and understood the material. If the assessment determines they have not learned the material, they are given a review that ensures the learning is satisfactory before proceeding. The system may prevent children from moving forward in a program when they have not yet mastered the material.

The continuous assessment is related to customizing the online literacy system to each child. The system continuously surveys a child's skills though a variety of assessment methods and creates a customized profile for each child. The customized profile may help determine if a child already knows the material to be taught. If the customized profile indicates that they already know the material, they may skip it. If the customized profile indicates that the child does not know the material, they may be taught it.

The continuous assessment and customized profile may take place throughout the online literacy system. For example, the assessment may take place before the child enters the program to determine the appropriate starting point. The results of the initial assessment may be incorporated into the customized profile. Assessment may also take place throughout the program so that a child does not waste time learning any words that they already know. The information from this continuous assessment may be incorporated into the customized profile as the child proceeds through the program.

The online literacy system may 200 provide continuous assessment and customization by using computer implementation and algorithms. For example, the assessment and customization systems may use a hash table or database to store user results. This allows user results to be retrieved instantaneously. The system may immediately know whether a child already knows a certain word, so the system can skip words that the child already knows in real time.

The assessment system and skills survey may be short and operate at multiple levels and in multiple places of the system. It may be more accurate and helpful to have a series of short assessments at various places instead of a long assessment at fixed places (e.g., a long assessment every week or a long assessment after the child finishes each level). The system 200 may include an initial assessment when the child first begins the program to determine if the child needs assistance in using a mouse and keyboard. The system 200 may include another assessment to determine if the child should learn pre-reading skills or continue to reading/writing skills. The system 200 may include other assessments before a child learns words to determine if the child knows the word. The system 200 may include an assessment after each book to determine if the child knows all of the words in the book. The system 200 may include an assessment before a child continues to the next level.

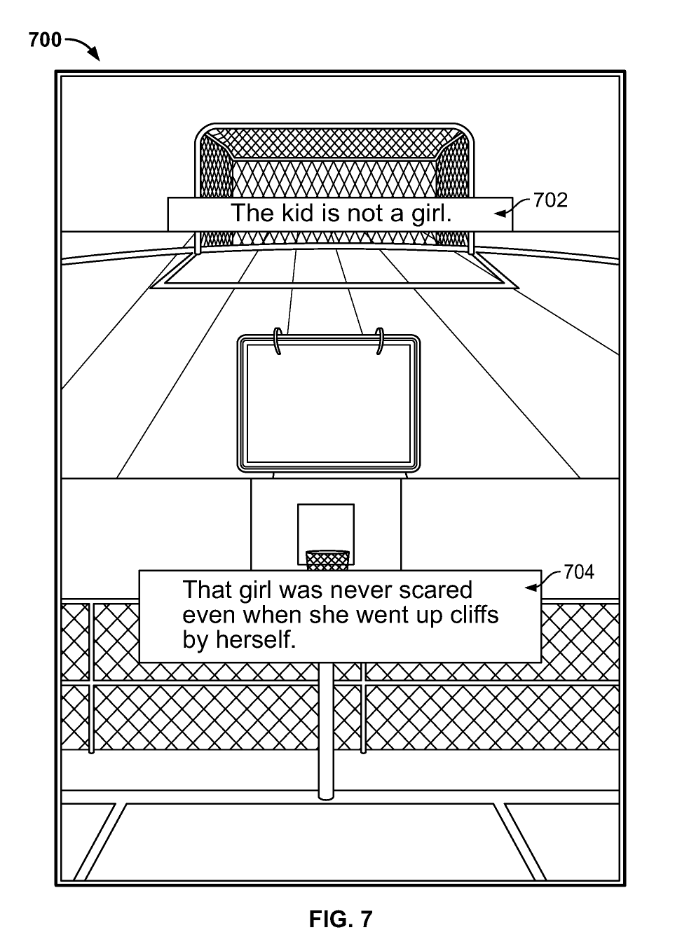

FIG. 7 illustrates a basic example of assessment 700 that may be offered by the online literacy system. The system may automatically take a child to the most appropriate place for learning given their current abilities. The system may do this using the Skills Survey, Progress Check, and the review. These may evaluate a child's knowledge to determine if they already know information (in which case they do not need to spend time learning it) or if they have successfully learned the information that they have just been taught (and if not they receive a review). In contrast, in a non-computerized or paper-based literacy system, it may be possible to instruct parents or teachers what to do, but there is no way to control it. The parents or teachers may go to any part of the program they choose and they can skip any part of the program they choose to skip.

As shown in FIG. 7, the system displays sentences 702,704 that the child is required to type from dictation. If they can type these sentences 702,704 with minimal error, then they can skip the lessons taught at that level. FIG. 7 illustrates the sort of sentence a child has to write to pass level one. To pass level one of reading/writing, a child has to produce, via dictation, a sentence 702 like “The kid is not a girl.” FIG. 7 also illustrates the sort of sentence a child has to write to pass level five. To pass level five of reading/writing, a child has to produce, via dictation, a sentence 704 like “That girl was never scared even when she went up cliffs by herself.”

In some embodiments, an online literacy system 200 for teaching skills associated with literacy may require and reinforce left to right sequencing. Left to right sequencing is a basic skill in literacy and may be neglected in literacy instruction. Many people know that left to right sequencing must be mastered as part of a literacy system, but some literacy systems fail to teach it. Some literacy systems may assume that children will learn left to right sequencing inherently or on their own.

The online literacy system 200 may be set up throughout to require left to right sequencing. If a word is to be filled in, the letters may only be able to be entered from left to right. For example, if the word is “girl,” the ‘i’ cannot be entered before the ‘g,’ the ‘r’ cannot be entered before the ‘i,’ etc. This may occur in almost every format and in the writing required in some books. The system may ask the user to type the letters to spell out “girl.” Even if the child knows that “girl” is made up of the four letters ‘g,’ ‘i,’ ‘r,’ and ‘I’ the child may only be allowed to enter the letters in the correct order. If the child attempts to enter the ‘i’ first, the system may play a beep or present an error message. The message may remind the child that words appear in a left to right sequence. The message may remind the child that letters that go before other letters will appear to the left and letters that go after other letters will appear to the right. The message may remind the child that the first letters of a word appear on furthest to the left and that the last letters of a word appear furthest to the right.

The system 200 may continue to reinforce left to right sequencing in every game format and every aspect of the system 200 that involves typing letters. The system 200 may reinforce that words and sentences are sequenced from top to bottom. The sequencing of left to right and top to bottom may be intuitive for experienced readers, but it may not be intuitive for beginning readers. For example, some foreign languages, such as Asian languages do not involve left to right and top to bottom sequencing. As a result, teaching the skill of left to right sequencing may be especially valuable to some children who already know certain foreign languages.

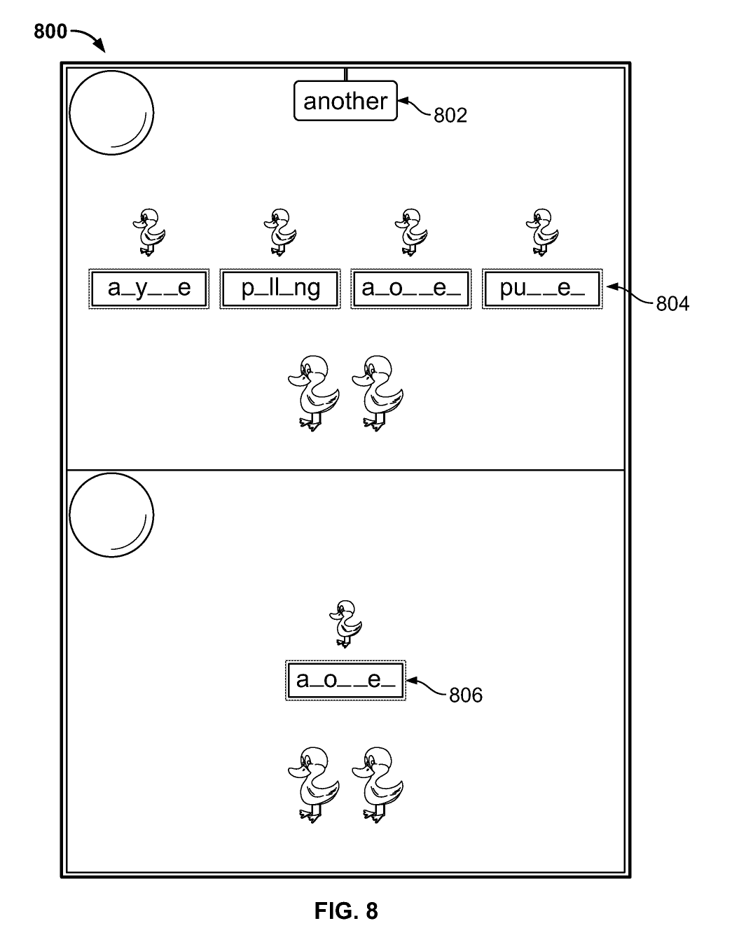

As shown in FIG. 8, the child may participate in a game format 800 where a child may first select the option that could make the target word “another” 802. The child must then fill in the missing letters of the word from left to right 804. In the example, the missing letters from “another” are the letters ‘n,’ ‘t,’ ‘h,’ and ‘r.’ The child must fill in the ‘n’ before the ‘t,’ the ‘t’ before the ‘h,’ and the ‘h’ before the ‘r’ 806. The child must only fill in the missing letters in this correct order from left to right. In contrast, in a paper worksheet, the child may be able to fill in the letters in any way, such as the letters ‘t,’ ‘h,’ and ‘r’ first.

In some embodiments, an online literacy system 200 for teaching skills associated with literacy may teach language in a systematic manner. Traditional systems that teach reading may assume that, aside from needing to know how to link letters and sounds, a child possesses via spoken language the language skills that are required for literacy. In other words, traditional literacy systems may assume that language mastery is a given, rather than a skill that needs to be developed. As a result, traditional literacy systems may present children with sentences that they may not yet comprehend in spoken language. In addition, by focusing on sounds, traditional literacy systems may present idiosyncratic sentences that may be confusing such as “Bill bit the belt.” Traditional literacy systems may also ignore the structures that they present to children in teaching them words. As a result, traditional literacy systems may present books that are overly complex.

The online literacy system 200 may teach language in a systematic manner and teach the structure of language. The teaching of language may be helpful to children who do not come from literate backgrounds (which may represent a high percentage of the United States population) and may be important to the teaching of English. The teaching of language may also allow the system 200 to teach English as a second language.

For example, to teach the structure of language, the system 200 may teach not only nouns and verbs, but certain non-content words that go with the nouns and verbs. The non-content words that go with nouns may include “the,” “this,” “these,” “some,” etc. The non-content words that go with verbs may include “is,” “ing,” “did,” “was,” “had,” etc. The system 200 may teach literacy using a combination of nouns, verbs, and non-content words. The system 200 may use even a limited number of nouns, verbs, and non-content words as the basis to start teaching the structure of real language. The system 200 may begin to teach language using simple sentences such as “The girl is sitting,” “He wants to run,” “They like to play,” and “She was eating.”

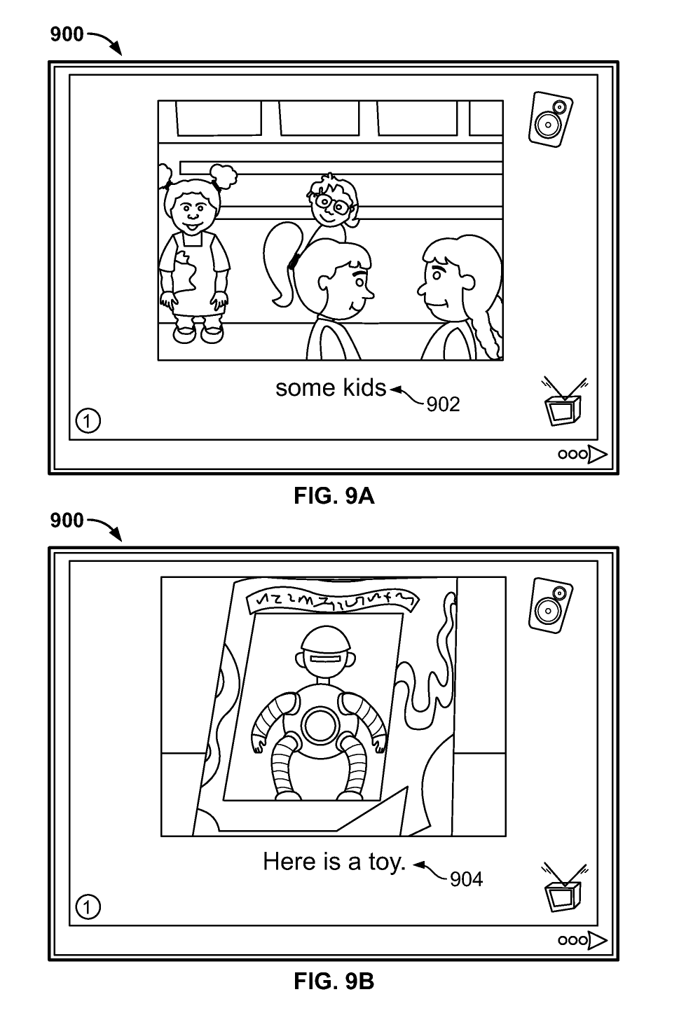

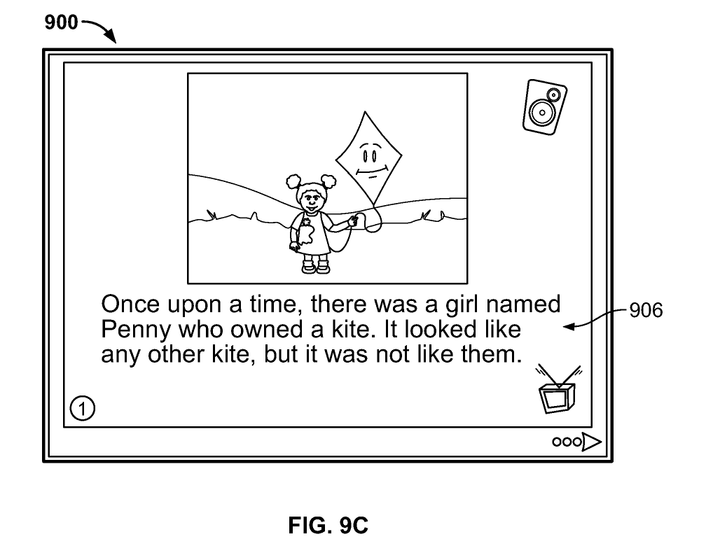

FIGS. 9A-9C illustrate basic examples of teaching language 900 that can be offered by the online literacy system 200. As shown in FIG. 9A, children may start off with simple structures that include non-content word and one noun 902. The simple structure may be the phrase “some kids.” Subsequently, as shown in FIG. 9B, children may progress to simple complete sentences that include non-content words, nouns, and verbs 904. The simple complete sentence may be the sentence “Here is a toy.” Subsequently, as shown in FIG. 9C, children may steadily progress to more complex sentences that contain more (and possibly more complex) non-content words, nouns, and verbs 906. The more complex sentences may be the sentences “Once upon a time, there was a girl named Penny who owned a kite. It looked like any other kite, but it was not like them.”

In some embodiments, an online literacy system 200 for teaching skills associated with literacy may provide automatic correction of error. The online literacy system 200 may provide automatic error correction in all of the games and formats. In all of the games and formats, the system 200 may stop immediately at any error and make the child correct it. Automatic and immediate correction of error may increase the effectiveness of learning. Automatic and immediate correction of error may ensure that the child learns from their mistakes before forgetting anything. The mistakes will still be fresh in the child's mind. In addition, correction of error may ensure that the child does not develop any bad habits such as mistakenly believing that an incorrect spelling or rule is correct. The child's errors will be corrected immediately, so the child will always know the correct spelling or rule.

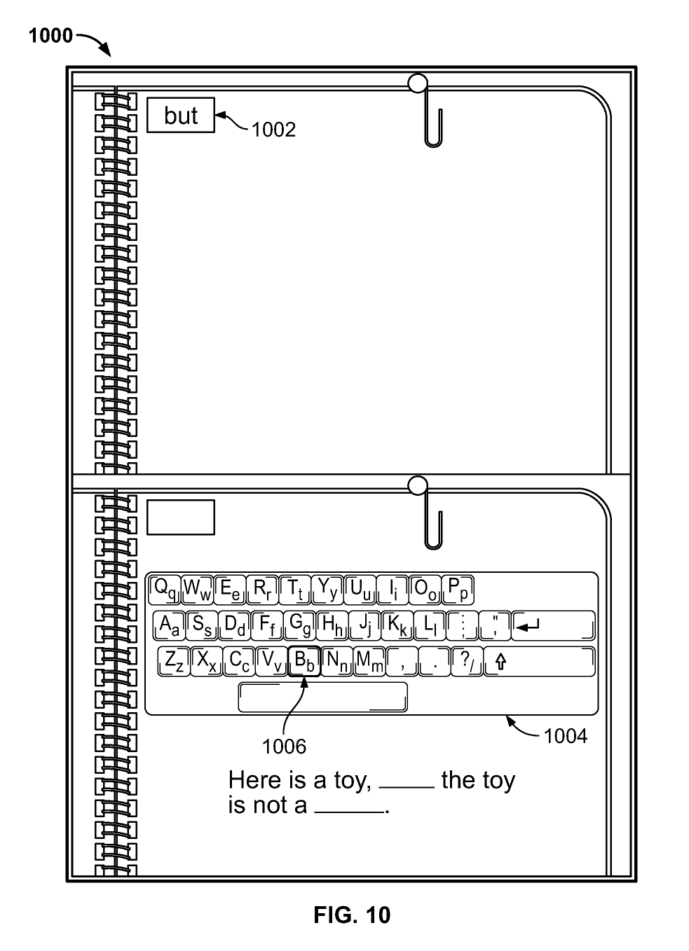

As shown in FIG. 10, the child may participate in a game format 1000 where the target word “but” 1002 is displayed but that word must be typed by the child. In the game format 1000, the child must type the letters ‘b,’ ‘u,’ and ‘t’ in the correct order. If a child types in a wrong letter, there is automatic and immediate error correction. For example, if the child types the letter ‘v,’ the system may play a sound indicating that the letter is incorrect. In addition, the screen may stay the same and no additional letters are filled in. Instead, a keyboard screen 1004 appears highlighting the letter that needs to be typed. In this case, the letter ‘b’ 1006 is highlighted by the keyboard that appears. The child is informed of the correct letter that needs to be typed and is informed that typing the letter ‘v’ is incorrect. This provides only a basic example of automatic and immediate error correction. There are different and more complex types of error correction throughout the system.

In some embodiments, an online literacy system 200 for teaching skills associated with literacy may provide feedback or reports to adults about the child's results. The feedback or reports may offer pointers and recommendations to adults based on the child's performance, such as identifying problem areas or making recommendations for improvement if the child's performance is unsatisfactory. The feedback or reports may be generated constantly or after certain triggering events (for example every week or every time a child finishes a level). The feedback or reports allows adults to stay informed of the child's progress. Adults may receive regular e-mail updates of feedback or reports, or the feedback or reports may be displayed on the adults section of the system's website.

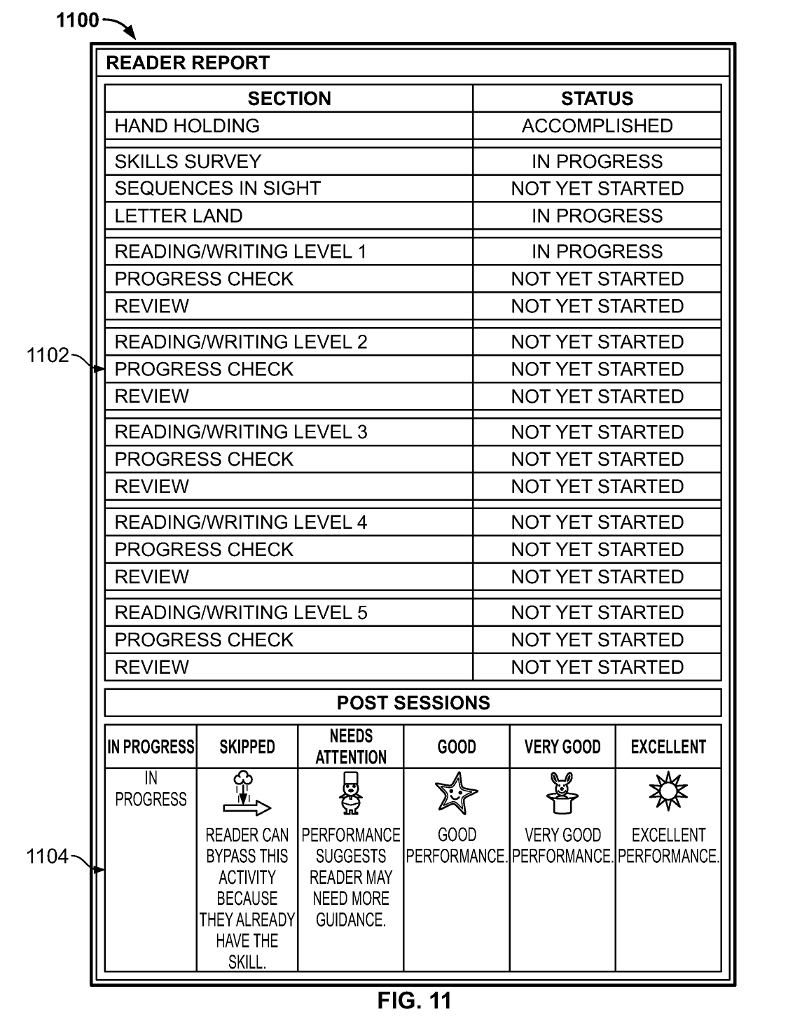

FIG. 11 provides a basic example of the type of Reader Report 1100 that may be available to adults. The report 1100 may be sent via e-mail to the adult (including a link to the report or an actual copy of the report). In addition, adults always have access to the report on the online literacy system's website. The feedback or report 1100 offers information about a student's progress through the system 200. For example, the report shows the child's progression through the program. It shows that the child has finished the Hand Holding section and is currently working through pre-reading skills and the first level of reading/writing skills. The report shows that the Skills Survey, Letter Land, and Reading/Writing Level 1, are in progress, but the other sections have not yet been started.

In addition, report 1100 contains additional indications 1104 such as In Progress, Skipped, Needs Attention, Good, Very Good, or Excellent. These indications may represent the child's qualitative results on a particular section of the online literacy system 200.

FIG. 11 provides a basic example of a Reader Report 1100. The online literacy system 200 may contain many other types of feedback or reports, including feedback or reports that contain more specific or sophisticated results and statistics.

In some embodiments, an online literacy system 200 for teaching skills associated with literacy may skip material that the child already knows. This feature is related to the assessment system 208 (which determines what material the child already knows) but it is also an independent feature that makes the online literacy system 200 more efficient and effective. The skipping of material that the child already knows is an automated and immediate feature. In a non-computerized or paper-based literacy system, the adult may have to make a judgment about which material to skip. In an online literacy system, the system 200 automatically judges which material to skip. This may be faster and more efficient from the point of view of the user. The decision about which material to skip may also be more accurate, as it is based on the information stored by the system 200, as opposed to an adult's subjective judgment.

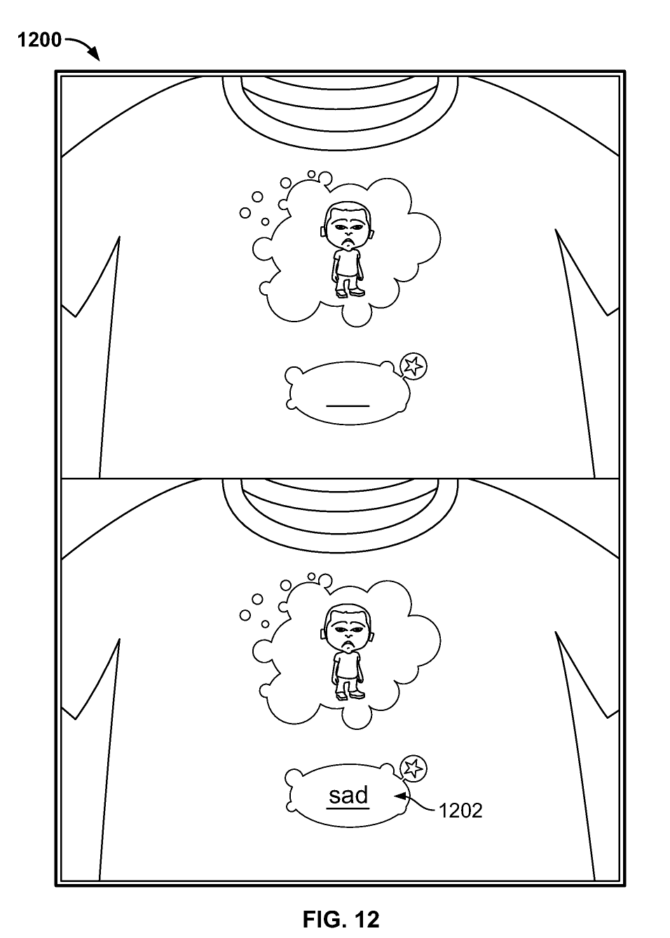

As shown in FIG. 12, the child may participate in a game format 1200 where the child is asked to type the word “sad” 1202. If the child can type the word correctly, the child demonstrates sufficient mastery of the word, so the teaching activities and exercises for the word are skipped because the child already knows it. On the other hand, if the child is unable to type “sad” correctly, the child will continue with the teaching activities and exercises for “sad.” This provides a basic example of skipping material the child already knows.

In some embodiments, an online literacy system 200 for teaching skills associated with literacy utilizes techniques to emphasize meaning and comprehension. Meaning can be an important part of literacy education. Some typical early reading education programs may confront children with endless pages of words that have nothing to do with one another. In contrast, the online literacy system 200 may present children with words and sentences that actually mean something, like the words and sentences encountered in real life.

For example, the system 200 may use interactive graphics to teach the meaning of language. The graphics that can be presented in an online literary system 200 may be richer and more instructive than the graphics that can be presented in a non-computerized or paper-based literacy system. The online literacy system 200 can present graphics in ways that make children think about the meaning of language. The system 200 may have a child work with a sentence, and only after completing the sentence does a graphic appear to illustrate its meaning. The sentence can be “One thing here can fly” and only after they complete the exercise for the sentence do they see three animals: a worm, a dog, and a bird. The child will understand that the bird is the only animal that can fly, which helps to reinforce the meaning of the sentence they have just learned.

Similarly, the online literary system 200 may teach meaning in different contexts and at higher levels. For example, the system 200 may teach reading comprehension through stories and books. The system 200 may use teaching techniques to enable children, after reading a message, to grasp and convey the “main idea” of a story. This is illustrated through the teaching format Gleaning Meaning which is part of advanced books.

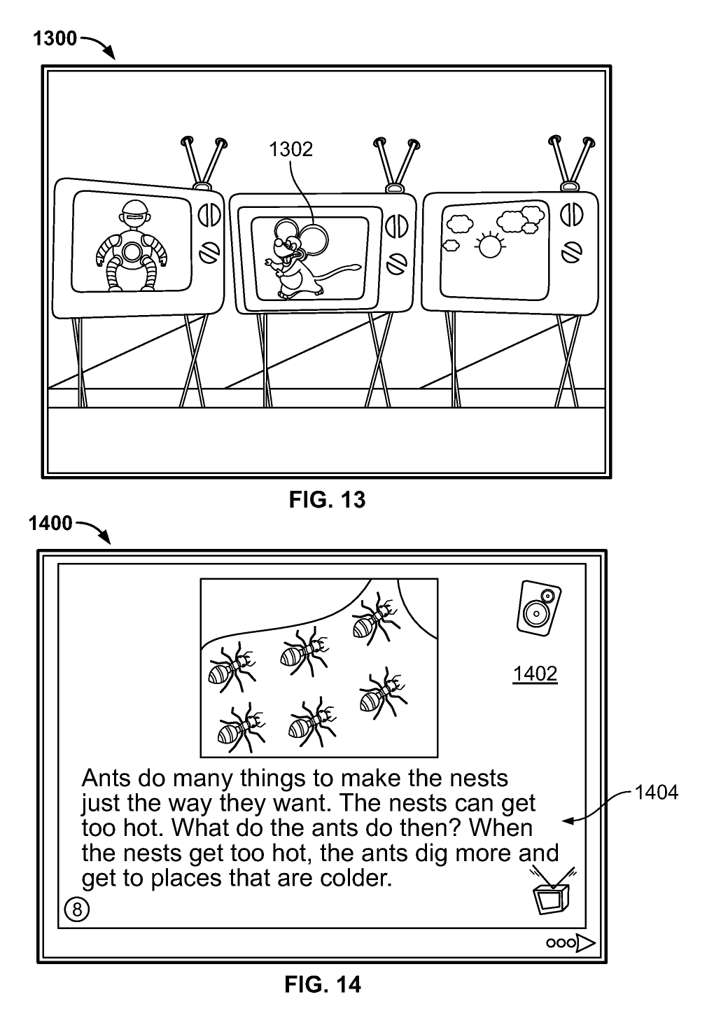

FIG. 13 shows a game format 1300 in which a child hears the word “animal” and must select the correct picture between a robot, mouse, and balloon. The child may only able to pass the game by understanding the meaning of “animal.” If the child understands the meaning of “animal,” the child may be able to correctly select the picture of the mouse 1302.

In some embodiments, an online literacy system 200 for teaching skills associated with literacy uses sound to support the link between written and spoken language. The system 200 allows the child to hear the words and stories to be read aloud, so the link between spoken and written language is more direct. This creates a clear connection between the two systems. This may also help the online literacy system 200 to teach English as a second language to non-English speakers. Hearing the words and stories read aloud also helps the child to understand the meaning and comprehension of words and stories.

A non-computerized or paper-based literacy system may have difficulty in using sound to support the link between written and spoken language. A non-computerized or paper-based literacy system cannot allow the child to hear the words or stories to be read aloud. It is possible that the child can complete an entire non-computerized or paper-based literacy system without speaking or hearing the words or stories. This may create a gap between written and spoken language, and make it more difficult for the child to master all of the skills required for total competency in literacy. The online literacy program 200 avoids these difficulties by always supporting the link between written and spoken language.

For example, as shown in FIG. 14, whenever the speaker icon 1402 is visible (shown in the figure to the right side of the book 1400), a child can click on the words that are displayed to hear the words spoken aloud. The page of the book 1400 has the text 1404: “Ants do many things to make the nests just the way they want. The nests can get too hot. What do the ants do then? When the nests get too hot, the ants dig more and get to places that are colder.” The child may have the option to have the entire paragraph read or individual sentences read aloud. The child may also click on specific words to have only specific words read aloud.

In some embodiments, an online literacy system 200 for teaching skills associated with literacy may be highly flexible and customizable. The online literacy system 200 may be more flexible and customizable than any non-computerized or paper-based literacy system. For example, the online system 200 can be used with modest time commitment. A child could use the system 200 for only 15-30 minutes per day for approximately four or five days per week. The system 200 may also complement any school-based reading instruction that a child is receiving. The system 200 may also be accessible via a website, so it is accessible to anyone and from anywhere. The system 200 may also be on a subscription basis, so the user need only to pay for what they need. An online literacy system 200 offers more control and customization options than can be offered in a non-computerized or paper-based system. As one example, the user can customize the sound options so that the child controls whether they want a story read aloud to them. This may empower a child by giving them more choices, giving children a sense of control that is helpful in the learning process.

In some embodiments, an online literacy system 200 may teach punctuation. Punctuation may not be a significant part of non-computerized or paper-based literacy systems, and it may not be taught often as a skill in early reading instruction.

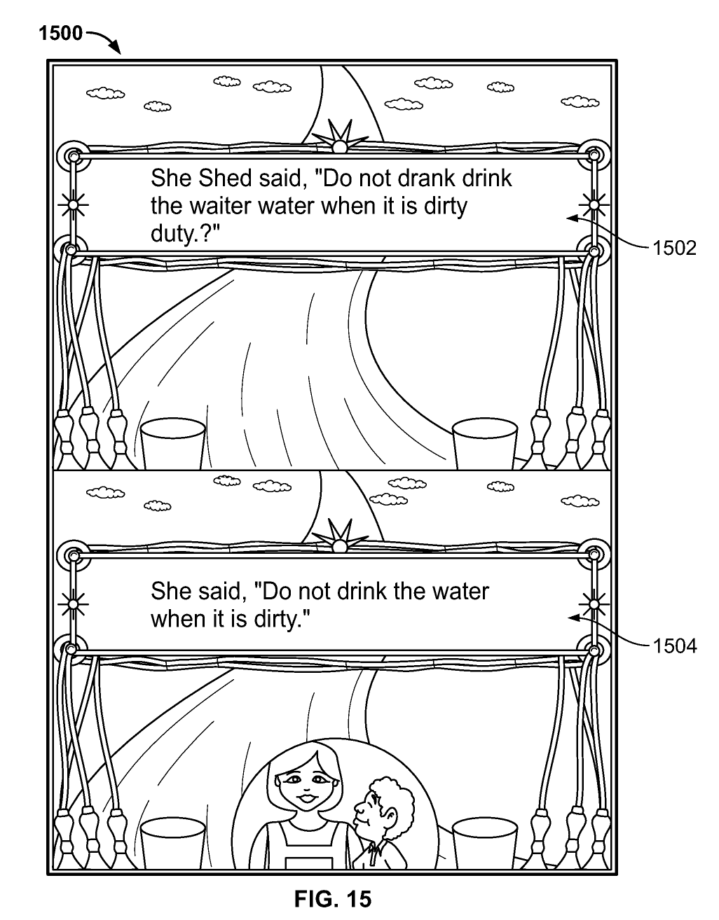

FIG. 15 shows a game format 1500 in which a child must type an entire sentence from dictation, including the punctuation 1502. The ability to type the words and punctuation correctly reflects a clear mastery of the words and punctuation 1504. In the example, the sentence contains several punctuation symbols, including a comma, quotation marks, a period, and a question mark. The child may pass the game if they type in the entire sentence, including the punctuation, correctly.

In some embodiments, an online literacy system 200 may teach use of a keyboard and mouse. The system offers adult-mediated training for enabling children to use the keyboard and mouse. This allows the child to operate the program and also provides useful training for operating a computer generally.

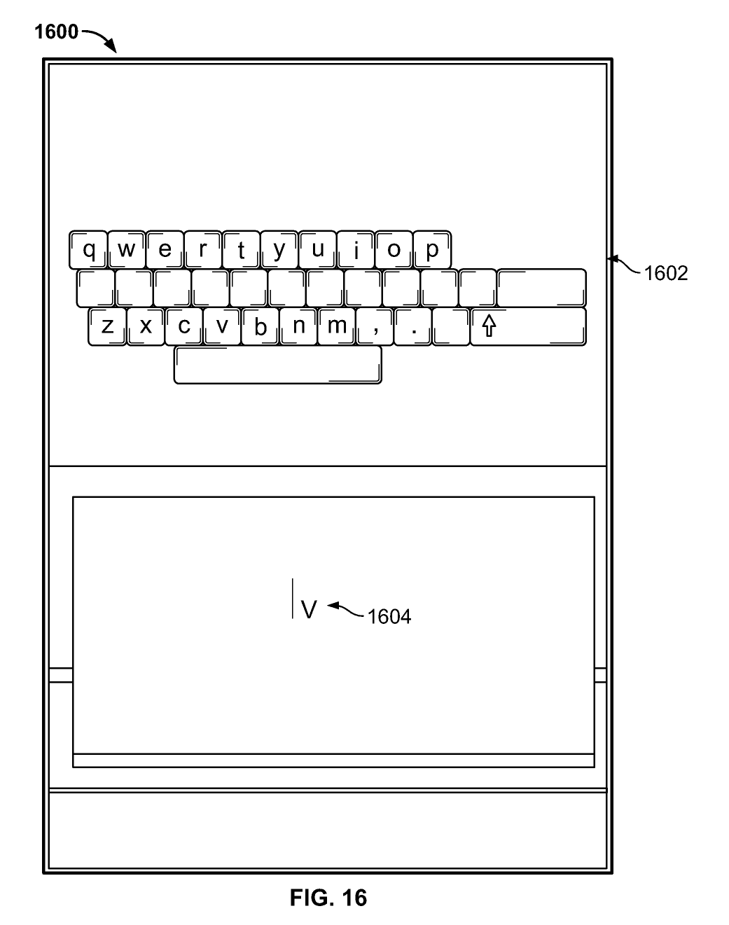

As shown in FIG. 16, the online literacy system 200 teaches a child how to effectively use the keyboard 1600, including the use of letters and punctuation. This simulates writing and facilitates writing production. FIG. 16 provides an example from a games format 206. The first screen 1602 shows a simplified keyboard that helps a child locate and select the keys. The second screen 1604 has a child repeat the key selection on the actual keyboard.

In some embodiments, an online literacy system 200 may force the child to write from memory. The system 200 may be able to guarantee that a child will write from memory as opposed to copying the solution. In a non-computerized or paper-based system, there is no way to guarantee that the child will write from memory. The child will only write from memory if the child follows the adult's directions. In an online literacy system 200, the child may be forced to attempt the formats and games without being able to see other aspects of the program. This way, the only way that the child can pass the games is by writing from memory.

In some embodiments, an online literacy system 200 may provide fun and entertainment. The system 200 may use fun, game-like, interactive formats to teach reading, so children do not get bored with boring, repetitive instruction. The system 200 may also include animation, artwork, music, and sound effects. This may make the system more entertaining for some children, and more like a video game for some children.

The online literacy system 200 may include many teaching formats 400. The teachings formats may include Seeing Sequences 408, Letter Land 410, Write in to Read 412, Replace the Space 414, Detect n Select 416, Find n Fill 418, 426, Savvy Sounds 420, Pick the Picture 422, and Stay n Play 424. The teaching formats 400 all teach one or all of the skills associated with competence in literacy, including total competence in reading, writing, and punctuation. For example, some teaching formats may teach the skill of writing. Teaching formats 400 that involve typing in words (such as Letter Land 410, Write in to Read 412, Replace the Space 414, Find n Fill 418, 426, Pick the Picture 422, and Stay n Play 424) may teach and reinforce writing.

The teaching format of Seeing Sequences 408 may teach the key skill of sequencing that allows readers to see combinations of identical letters as different words (such as “own” and “won”). Prior to reading, the sequence in which objects appear (such as a group of birds) does not affect its meaning. It is only with reading that visual sequencing becomes an essential skill. The online literacy system 200 may teach this skill for children who require it. A child must pass certain criteria in order to successfully complete this format. They continue doing the format until they are able to achieve criteria. If the child is unable to achieve criteria within a certain amount of time the parent/teacher is advised that the child may not yet be ready for the program and to take some time off before trying again.

The teaching format of Letter Land 410 may teach children how to effectively use the keyboard to write letters and words. Letter Land 410 is also a teaching format that teaches and reinforces writing. Knowing how to use the keyboard to write letters and words is a skill required before a child can begin to write effectively on the computer. A child must pass certain criteria in order to successfully complete this format. They continue doing the format until they are able to achieve criteria. If the child is unable to achieve criteria within a certain amount of time the parent/teacher is advised that the child may not yet be ready for the program and to take some time off before trying again.

The teaching format of Write in to Read 412 may be the introductory format for any non-content word. Write in to Read 412 is also a teaching format that teaches and reinforces writing. It uses the word in context and illustrates its meaning through illustrations and words. In Part A, a child sees a sentence with the target word missing and has to type it in. In Part B, the sentence appears again and then, depending on the trial, a certain number of the elements of the sentence (including words and punctuation) disappear and the child has to type in all the missing parts. In this way, a child gets training in reading and writing the word, using the word in context, and typing full sentences with words and punctuation.

The teaching format of Replace the Space 414 may involve a child seeing text with words that have missing letters. Replace the Space 414 is also a teaching format that teaches and reinforces writing. The text contains the new target word plus any words previously taught. The child first selects the complete word that fits one of the incomplete ones. Then he fills in the missing letters. The resulting combination of words offers a meaningful message, with the message being accompanied by a graphic that illustrates its meaning.

The teaching format of Detect n Select 416 may involve a child seeing a segment of a text containing several instances of a new non content word. The child then has to select, in order, all instances of the target word. (This trains children how to spot non content words which are often elusive to a reader.)

The online literacy system 200 may offer an improved version of Detect n Select 416 compared to the version that may be offered in a non-computerized or paper-based literacy system. For example, in Detect n Select 416, the system200 requires that the child go left to right and top to bottom. The child cannot select the word at just any point in the text. In contrast, in a non-computerized version, the child can select the word at any point in the text unless the child is stopped by the adult.

The teaching format of Find n Fill 418 may be divided into Part A and Part B. Find n Fill 418 is also a teaching format that teaches and reinforces writing. In Part A, a child sees four incomplete words and has to select the choice that can be made into the target word. This teaches a child to envision the absent target word and do mental manipulations with it (which assists in the development of visual memory which is key to reading). In Part B, once the choice has been selected, the child has to fill in the letters to complete the word (which teaches spelling).

The online literacy system 200 may offer an improved version of Find n Fill 418 compared to the version that may be offered in a non-computerized or paper-based literacy system. For example, in Find n Fill 418, a child can only type in the correct word. In a non-computerized or paper-based version of Find n Fill, a child could try writing in any of the words and unless the child is stopped by an adult, the child could continue writing incorrect words.

The teaching format of Savvy Sounds 420 may be divided into Part A and Part B. In Part A, a test determines whether a child knows a word. If the child does know the word he/she bypasses the rest of the teaching for that word. If the child does not know the word, they go on to Savvy Sounds Part B. In Part B, the online literacy system 200 supplies the sound of the first part of the word and the child has to pick the word that represents the full word. This teaches children the key skill of sound analysis while simultaneously reducing the demands for the blending of word sounds which is typically one of the hardest things for a young child to do (this greatly reduces errors).

The online literacy system 200 may offer an improved version of Savvy Sounds compared to the version that may be offered in a non-computerized or paper-based literacy system. For example, in Savvy Sounds 420, the system 200 contains sentences to help the child recognize the word in question. Also, in cases with homonyms, the online literacy system 200 has sentences to disambiguate the meaning (e.g. “plane” versus “plain”). So if the online literacy system wants “plane,” it can say “The plane is flying,” and then the child has to type in the word. The non-computerized literacy system lacks these features.

The teaching format of Pick the Picture 422 may be divided into Part A and Part B. Pick the Picture 422 is also a teaching format that teaches and reinforces writing. In Part A, a child has to pick a picture that reflects or demonstrates a word. This links words to their meaning. In Part B, a child has to type the word which solidifies knowledge of the word and teaches spelling.

The online literacy system 200 may offer an improved version of Pick the Picture 422 compared to the version that may be offered in a non-computerized or paper-based literacy system. For example, in Pick the Picture 422, the system 200 may provide one set of pictures at a time and the child has to attend to find it. The online literacy system 200 can “control” the children's eyes, whereas in the non-computerized version the child is forced to scan all over the place. The result is that the process in the online literary system is much more systematic.

The teaching format Stay n Play 424 may be divided into Part A and Part B. Stay n Play 424 is also a teaching format that teaches and reinforces writing. In Part A, a child sees words that are similar to each other (generally by having similar starting letters) and he or she has to select the words that are requested by the program through an audio prompt. This helps children overcome the strong error pattern of relying on starting letters to guess at a word, rather than processing the complete word. At the end of the selection, the child has made a sentence. In Part B, the sentence re-appears and then, depending on the trial, a certain number of the elements of the sentence (including words and punctuation) disappear and the child has to type in all the missing parts. In this way a child gets training in reading and writing the word, using the word in context, and writing full sentences with words and punctuation.

The online literacy system 200 may offer an improved version of Stay n Play 424 compared to the version that may be offered in a non-computerized or paper-based literacy system. For example, in Stay n Play 424, the system 200 may tell the children the words to select, which reinforces learning. The children are able to be instructed which words to select using the audio capabilities of the online literacy system 200. In contrast, the non-computerized or paper-based version of Stay n Play 424 may just have kids cross out words, which has no connection to meaning.

All of the online literacy program teaching formats 400 offer repeated trials to strengthen the development of the particular skills. The formats 400 also offer tutoring support for wrong responses, so that the child can learn from their mistakes and get to the correct response.

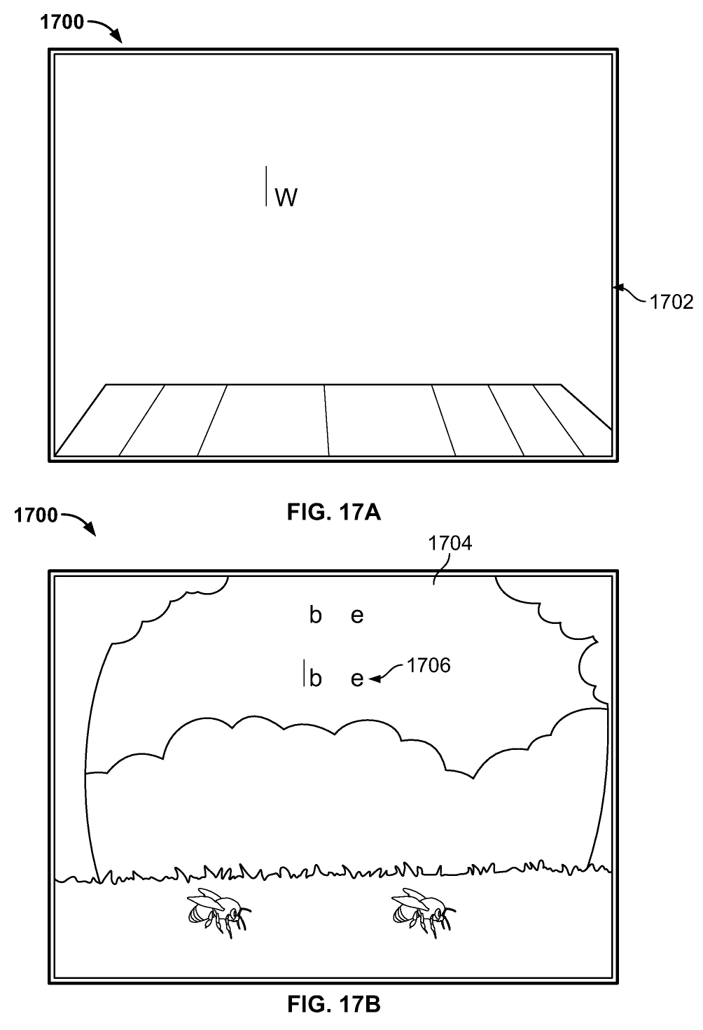

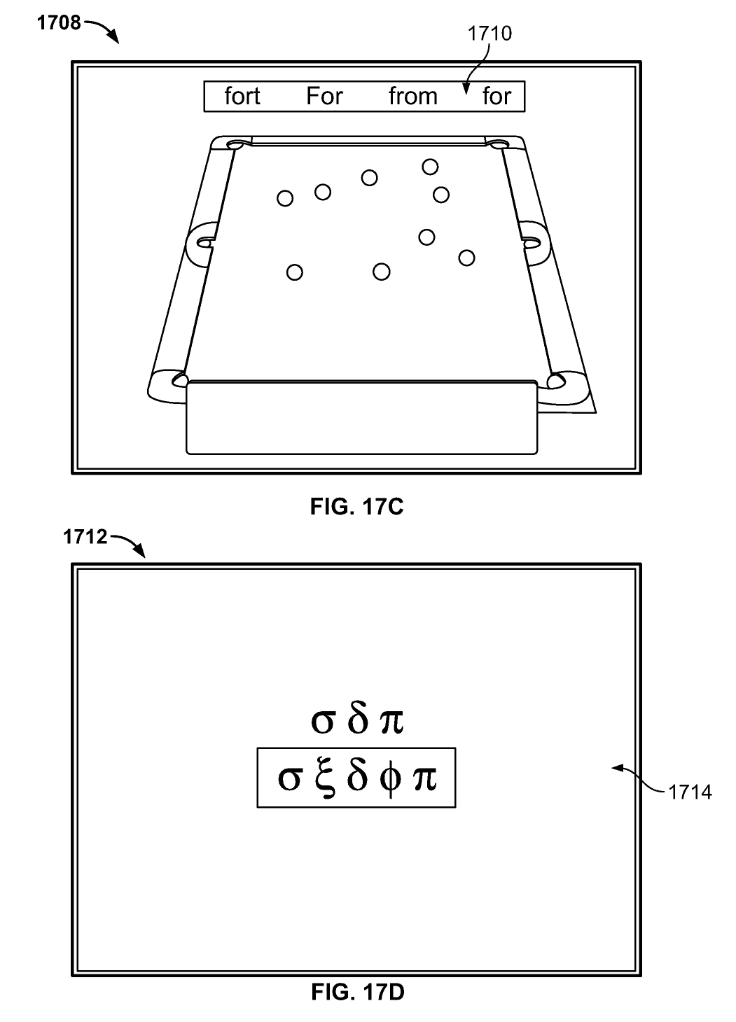

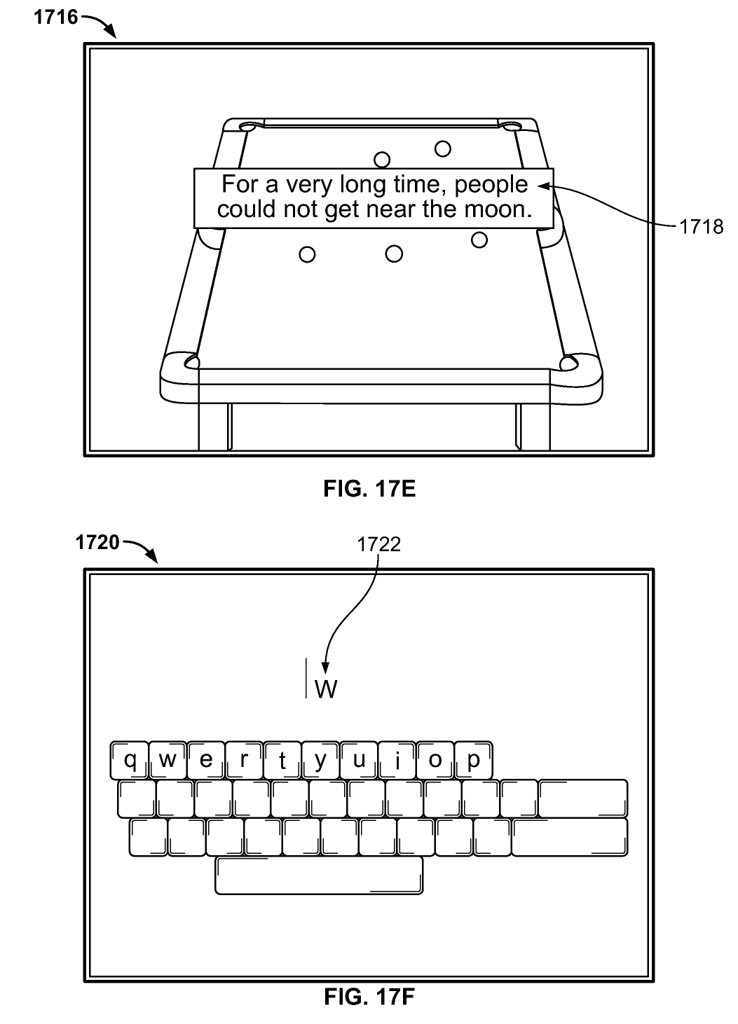

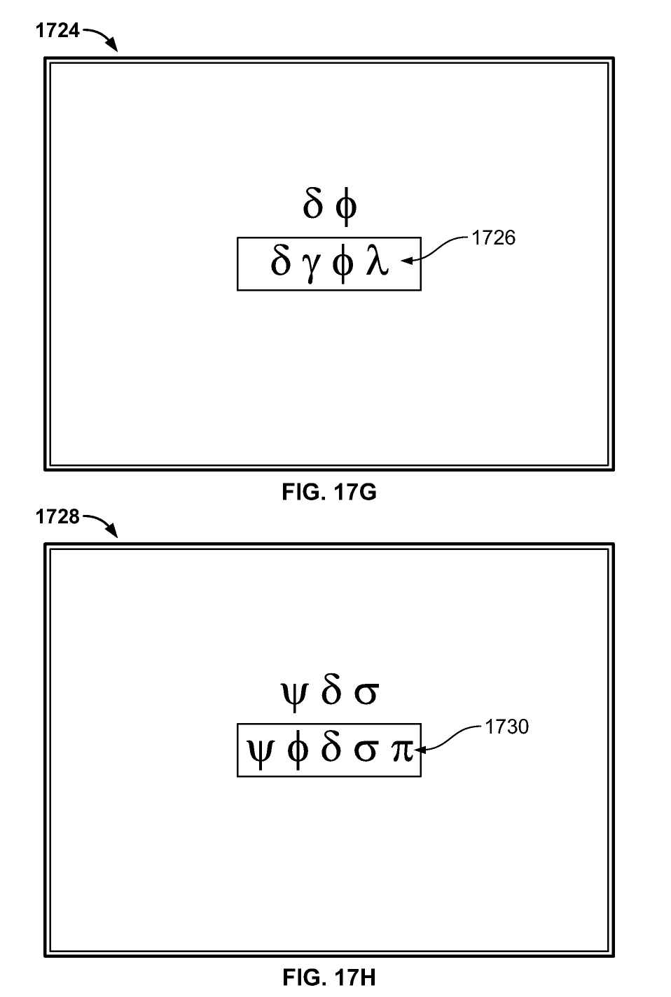

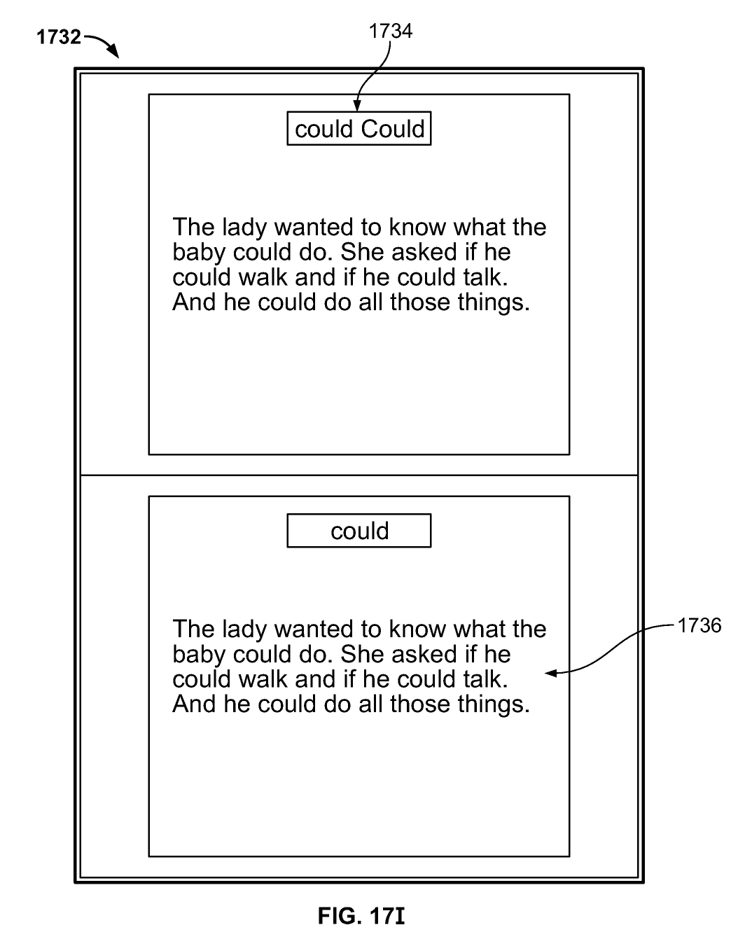

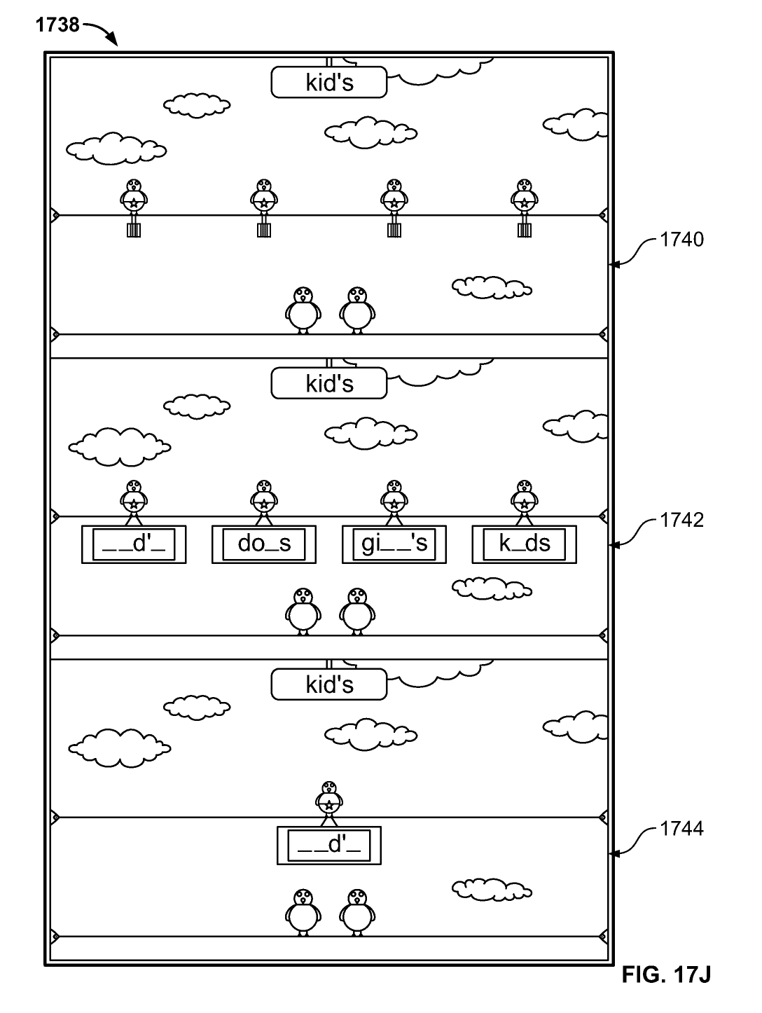

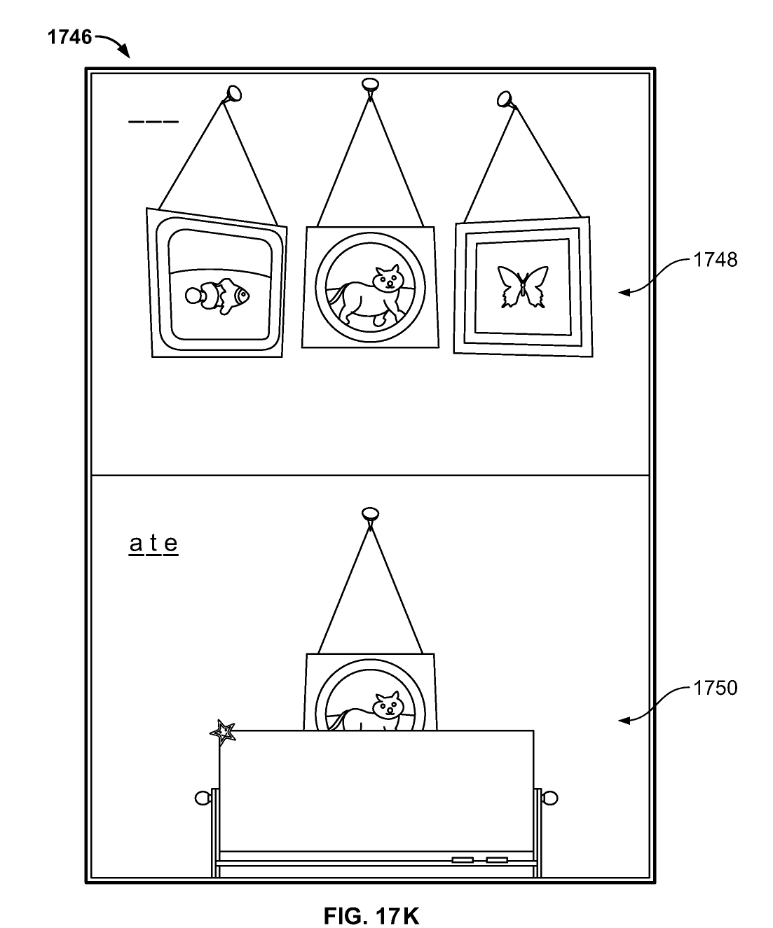

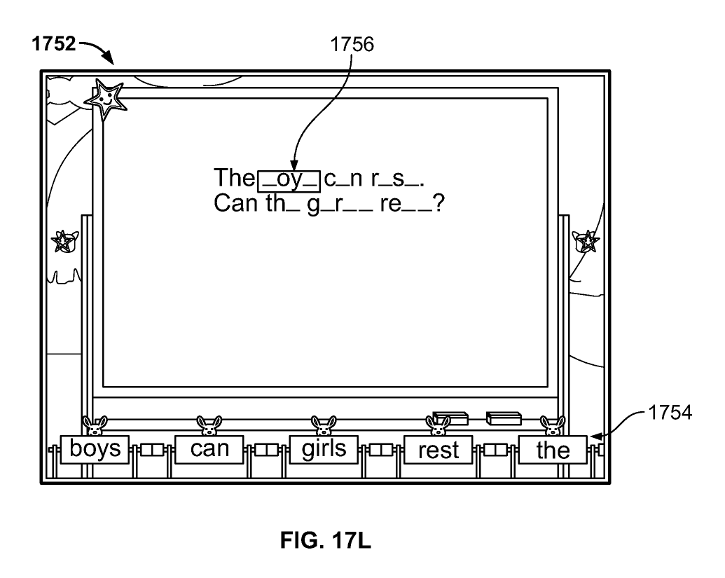

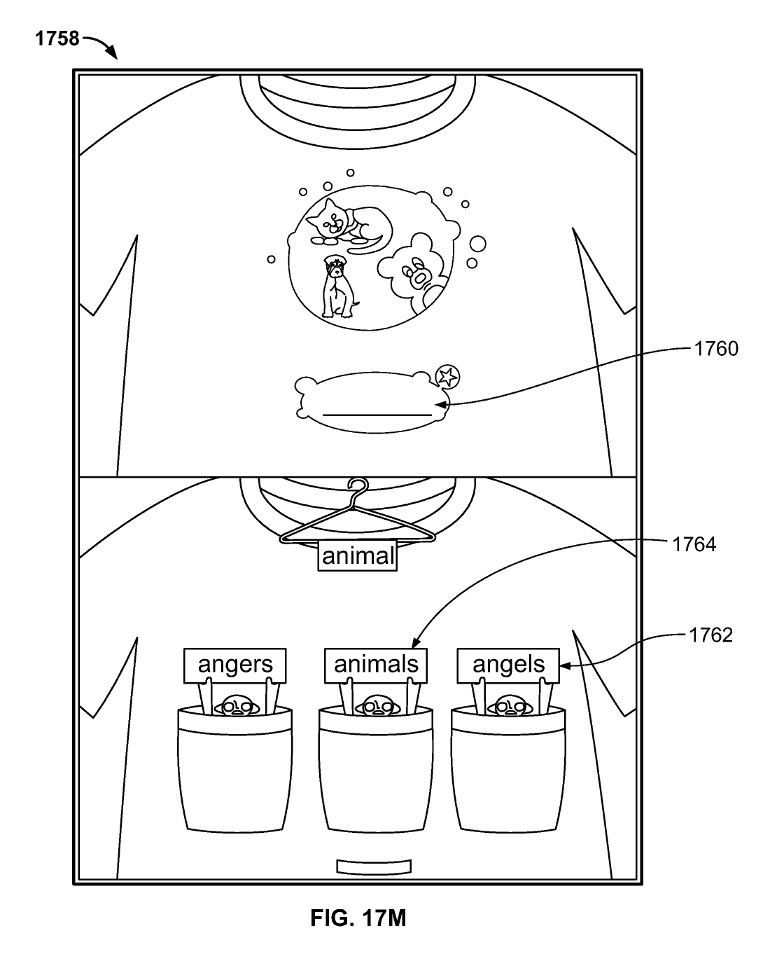

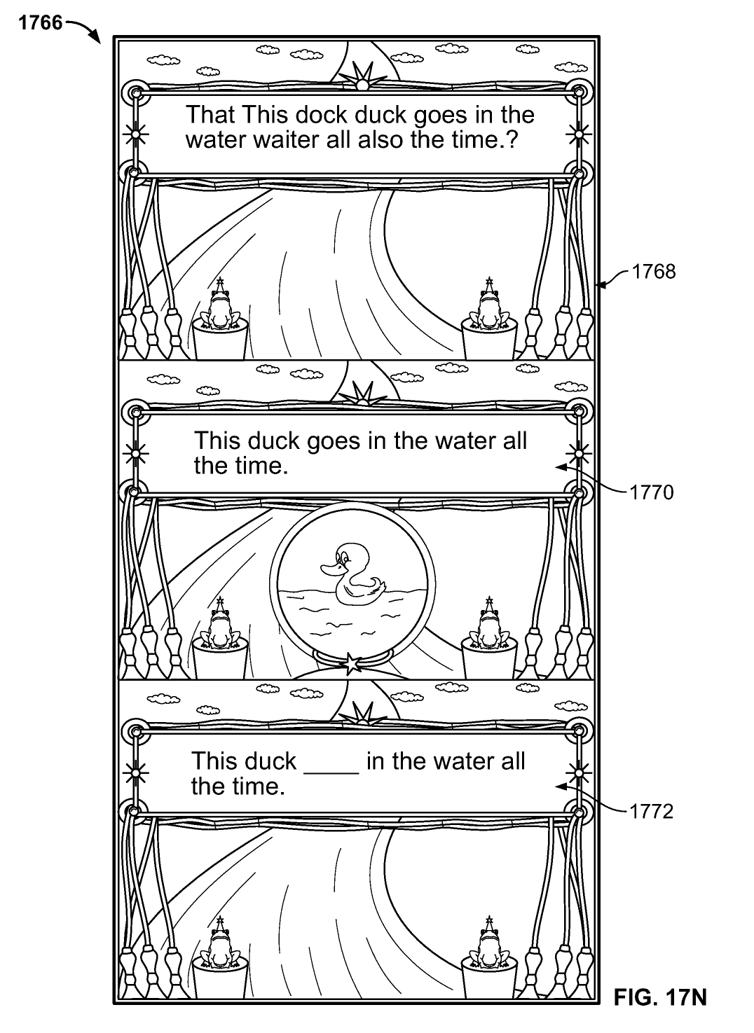

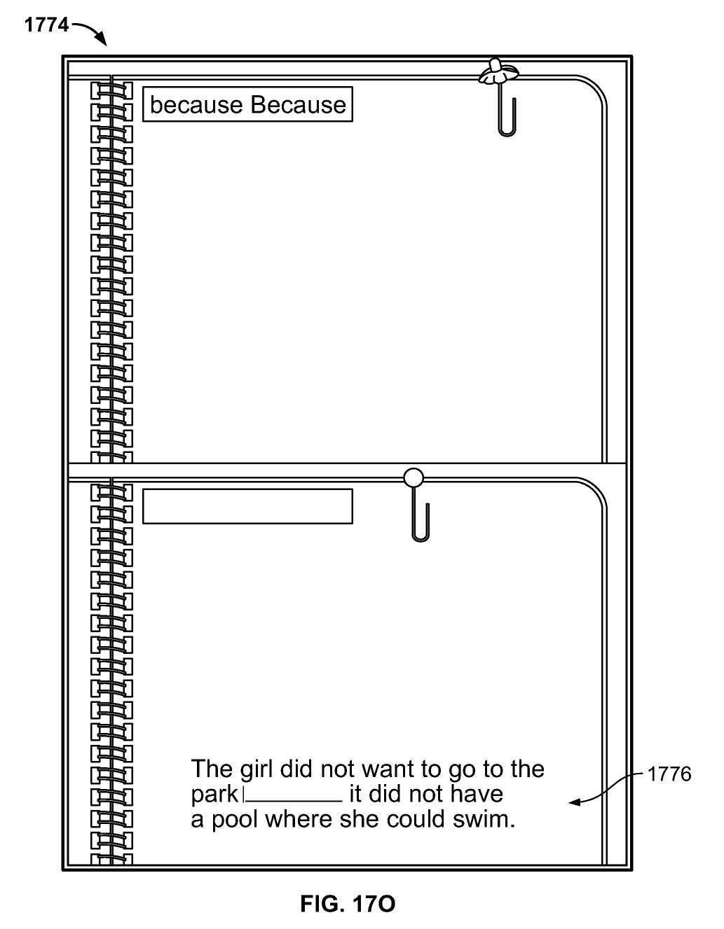

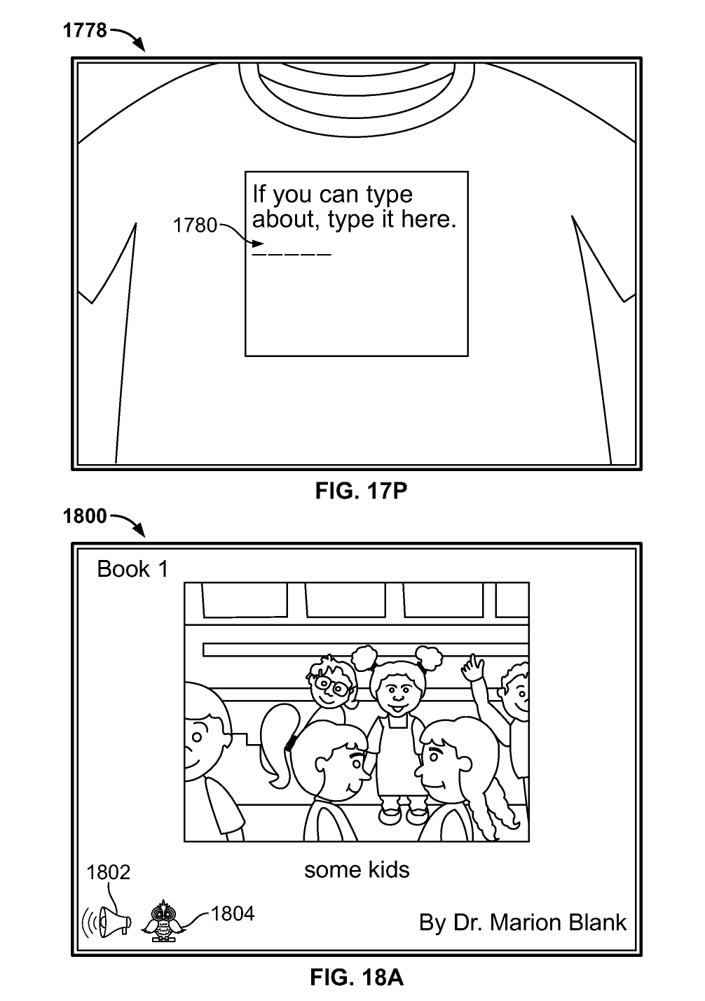

FIG. 17A depicts an example of a keyboard exercise 1700 in accordance with one embodiment of the invention. The system 200 may play the audio: “Type this on the keyboard.” The child may be presented with the letter ‘w’ on the screen 1702. The child may type the letter ‘w’ on the keyboard to pass the keyboard exercise.

FIG. 17B depicts an example of a keyboard exercise in accordance with one embodiment of the invention. The system may play the audio: “Type this on the keyboard.” The child may be presented with the word “be” 1704 on the screen. The child may type the word “be” 1706 on the keyboard to pass the keyboard exercise.

FIG. 17C depicts an example of a reading assessment exercise 1708 in accordance with one embodiment of the invention. The system may play the audio: “Click ‘for.”’ The child may be presented with the words “fort,” “For,” “from,” and “for” on the screen 1710. The child may click on the word “for” on the screen to pass the reading assessment exercise.

FIG. 17D depicts an example of a sequencing assessment exercise 1712 in accordance with one embodiment of the invention. The system 200 may play the audio “These are going to hide” followed by the top row of symbols flashing. The system 200 may then play the audio “Then click the same ones here” followed by the bottom row flashing. The child may be presented with two rows of symbols on the screen 1714. The child may match the symbols in the correct sequence to pass the sequencing assessment exercise.

FIG. 17E depicts an example of a writing assessment exercise 1716 in accordance with one embodiment of the invention. The system 200 may play the audio “Read this” followed by the words disappearing. The system 200 may then play the audio “Let's type that.” The child may type the sentence displayed 1718 to pass the writing assessment exercise.

FIG. 17F depicts an example of a keyboarding format 1720 in accordance with one embodiment of the invention. The system 200 may play the audio “Look at this” followed by the letter on top flashing. The system 200 may then play the audio “Click the same one here” followed by the keyboard on the screen flashing. The child may be presented with the letter ‘w’ above a keyboard on the screen 1722. The child may type the letter ‘w’ to pass the keyboarding format.

FIG. 17G depicts an example of a Seeing Sequences teaching format 1724 in accordance with one embodiment of the invention. In an early lesson, the symbols may stay on screen so that no memory is required. The system 200 may play the audio “Look at these” followed by the top row flashing. The system 200 may then play the audio “Click the same ones here” followed by the bottom row flashing. The child may be presented with two rows of symbols on the screen 1726. The child may match the symbols in the correct sequence to pass the Seeing Sequences teaching format 1724.

FIG. 17H depicts an example of a Seeing Sequences teaching form a 1728 in accordance with one embodiment of the invention. In a later lesson, the top may disappear so that memory is required. The system 200 may play the audio “These are going to hide” followed by the top row flashing. The system 200 may then play the audio “Then click the same ones here” followed by the bottom row flashing. The child may be presented with two rows of symbols on the screen 1730, where the top row of symbols may disappear. The child may match the symbols in the correct sequence to pass the Seeing Sequences teaching format 1728.

FIG. 17I depicts an example of a Detect n Select teaching format 1732 in accordance with one embodiment of the invention. The system 200 may play the audio “Find in order each word that says ‘could.”’ The system 200 may teach the word “could.” The child is presented with a sentence that contains the word “could” on the screen 1734. The child may select the word “could” 1736 to pass the Detect n Select teaching format 1732.

FIG. 17J depicts an example of a Find n Fill teaching format 1738 in accordance with one embodiment of the invention. The system 200 may teach the word “kid's.” The system 200 may play the audio “kid's” followed by showing the first screen 1740. The system 200 may then play the audio “Click the one that can become kid's followed by showing the second screen 1742. The system 200 may then play the audio “Type the letters to make” kid's” followed by showing the third screen 1744. The child may select the word that may become “kid's” and then type the letters to make “kid's” to pass the Find and Fill teaching format 1738.

FIG. 17K depicts an example of a Pick the Picture teaching format 1746 in accordance with one embodiment of the invention. The system 200 may teach the word “kid's.” The system 200 may play the audio “Click who ate a lot.” The child is then presented with three pictures and asked to click on a picture of a cat 1748. The system 200 may then play the audio “Type ‘ate,’” The child is then presented with three blank letters. The child may type the word “ate” 1750 to pass the Pick the Picture teaching format 1746.

FIG. 17L depicts an example of a Replace the Space teaching format 1752 in accordance with one embodiment of the invention. The system 200 may teach the word “can.” The system 200 may play the audio: “Click the word here” followed by the bottom words on the screen flashing 1754. The system 200 may then play the audio “That matches this one” followed by the highlighted word in the paragraph flashing. The system may then play the audio “Type this.” The child may click the word “_oy_” 1756 followed by typing the word “boys” to pass the Replace the Space teaching format 1752.

FIG. 17M depicts an example of a Savvy Sounds teaching format 1758 in accordance with one embodiment of the invention. The system 200 may teach the word “animals.” The system 200 may play the audio: “All these are animals. If you can type animals, type it here.” The child may be presented with a blank space 1760 to type the word “animals.” The system 200 may also play the audio “Click animals.” The child may be presented with three words: “angers,” “animals,” and “angels” 1762. The child may click on the word “animals” 1764 to pass the Savvy Sounds teaching format.

FIG. 17N depicts an example of a Stay n Play teaching format 1766 in accordance with one embodiment of the invention. The system 200 may teach the words “go,” “goes,” and “going.” The system 200 may play the audio “Click these” followed by the words flashing on the screen 1768, 1770. The system 200 may then show the third screen 1772 and play the audio “Click” followed by highlighting the word “goes.” Then following audio instructions to “click” selected words, the child clicks on the visual representations of the words to pass the Stay n Play teaching format 1766.

FIG. 17O depicts an example of a Write in to Read teaching format 1774 in accordance with one embodiment of the invention. The system 200 may teach the word “because.” The system 200 may play the audio “Because.” The system may then play the audio “Type because.” The child may be presented with a screen 1776 with the sentence “The girl did not want to go to the park ______ it did not have a pool where she could swim.” The child types the word “because” to pass the Write in to Read teaching format 1774.

FIG. 17P depicts an example of a review exercise 1778 in accordance with one embodiment of the invention. The system 200 may review the word “about.” The system 200 may play the audio: “About. If you can type about, type it here.” The child may be presented with a screen with a blank word 1780. The child types the word “about” to pass the review exercise 1778.

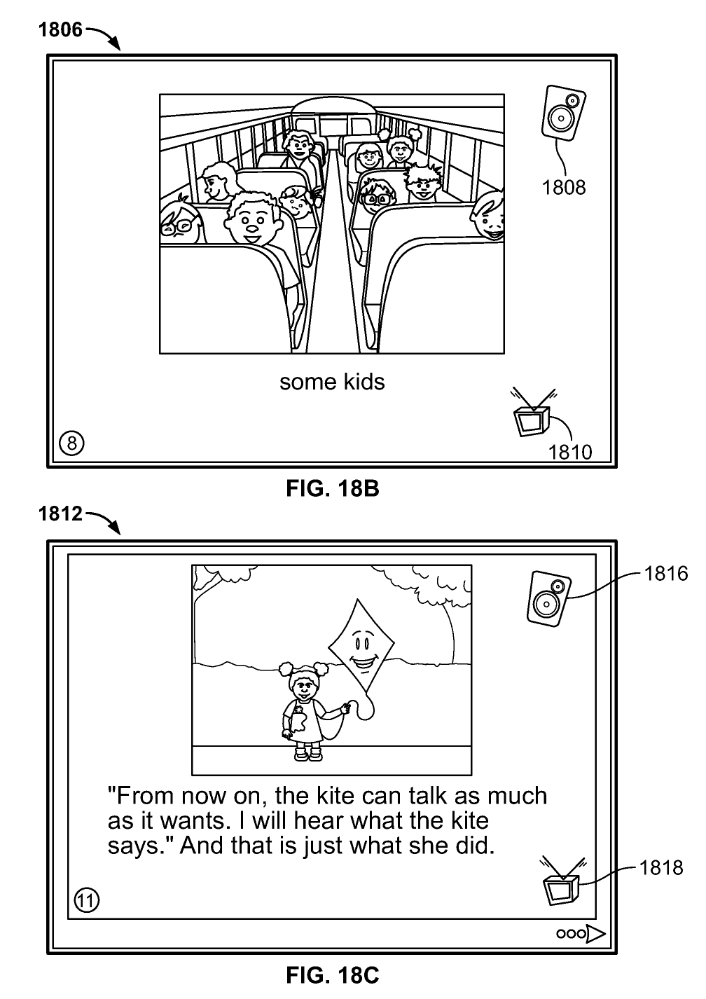

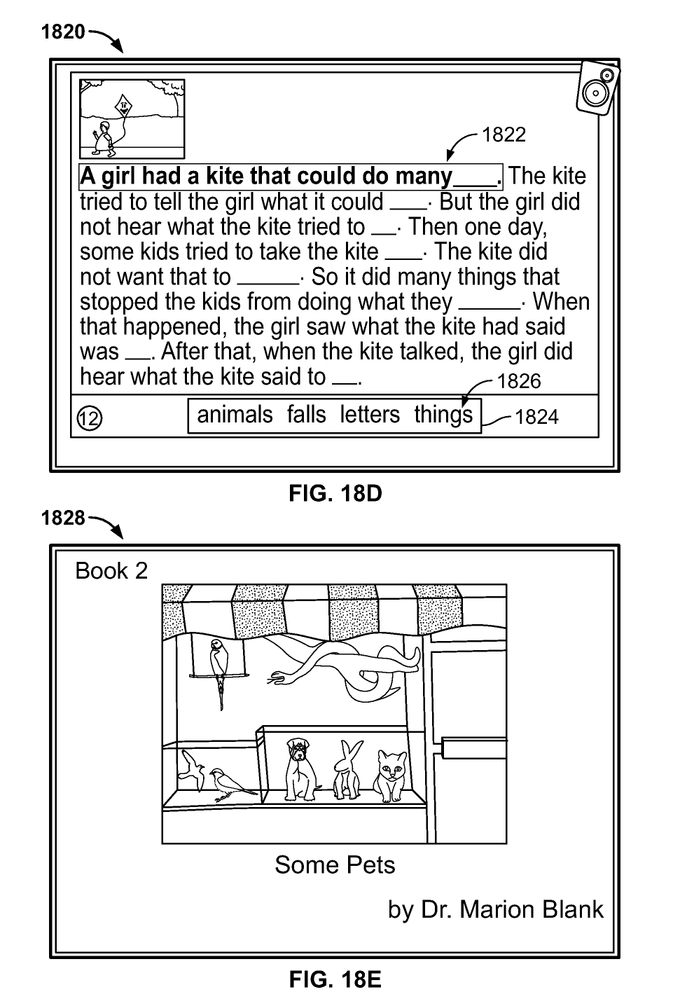

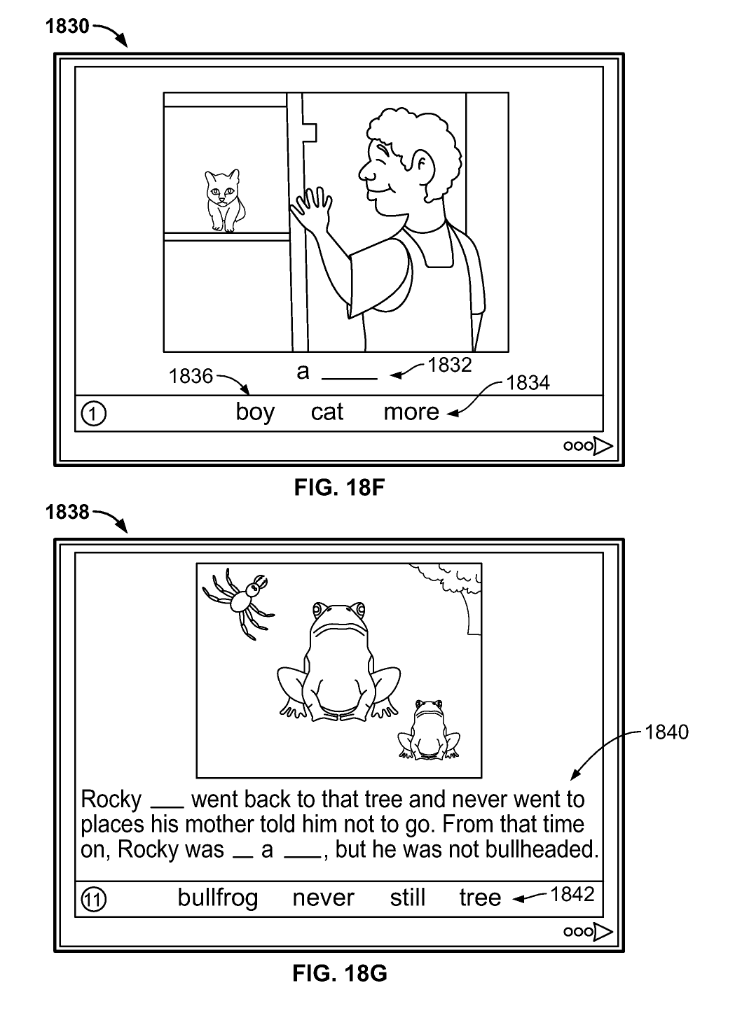

FIG. 18A depicts an example of the title page of a first story book 1800 in accordance with one embodiment of the invention. The system 200 may play the audio “To listen to the story click this” followed by the megaphone flashing 1802. The system 200 may also play the audio: “To read the story click this” followed by the owl flashing 1804. The child may choose to listen to the book by clicking on the megaphone 1802 or reading the book by clicking on the owl 1804. The child may click on the megaphone 1802 or the owl 1804 to pass the title page of a first story book.

FIG. 18B depicts an example of a page of a first story book 1806 in accordance with one embodiment of the invention. The system 200 may play the audio “To hear a word, click on it.” The child may be presented with the option of clicking on the speaker icon 1808, which allows them to hear a word. The child may also be presented with the option of clicking on the television icon 1810, which causes an animation to play. The child may click on the speaker 1808 or telephone 1810 or go to the next page to pass the page of a first story book.

FIG. 18C depicts an example of a page of a later story book 1812 in accordance with one embodiment of the invention. A later story book 1812 may be more complex. The child may be presented with a screen that shows the sentence “‘From now on, the kite can talk as much as it wants. I will hear what the kite says.’ And that is just what she did”1814. The child may be presented with the option of clicking on a speaker 1816, television 1818, or going to the next page to pass the page of the later story book 1812.

FIG. 18D depicts an example of a Gleaning Meaning teaching format 1820 which is part of an advanced story book in accordance with one embodiment of the invention. The system 200 may require the child to fill in sentences by clicking the correct word choice. The child may be presented with the sentence 1822 “A girl had a kite that could do many ______” on the screen. The child may be presented with word choices at the bottom of the screen 1824: “animals,” “falls,” “letters,” and “things.” The child may click on the correct word choice 1826, “things,” to pass the Gleaning Meaning teaching format 1820.

FIG. 18E depicts an example of the title page of a second story book 1828 in accordance with one embodiment of the invention. The system 200 may play the audio: “In this story you fill in words.” The system 200 may provide even numbered books that are fill-in books. The child may continue to the next page to pass the title page of the second story book 1828.

FIG. 18F depicts an example of a page of a second story book 1830 in accordance with one embodiment of the invention. The system 200 may play the audio “Click ‘Boy’” followed by “Type ‘boy’.” The child may be presented with the text 1832 “a ______” with three words: “boy,” “cat,” and “more” 1834 below it. The child may click on the word “boy” 1836 to pass the page of the second story book 1830.

FIG. 18G depicts an example of a page of a later even-numbered story book 1838 in accordance with one embodiment of the invention. A later even-numbered story book may be more complex than earlier books but contain the same fill-in option that is a feature of all-even numbered books. The child is presented with a screen with the text “Rocky ______ went back to that tree and never went to places his mother told him not to go. From that time on, Rocky was ______ a______, but he was not bullheaded” 1840. The child is also presented with words at the bottom of the screen 1842: “bullfrog,” “never,” “still,” and “tree.” Later even-numbered books may also have a Gleaning Meaning teaching format 1822. The child may click on the correct words to pass the page of the later even-numbered story book.

A number of embodiments of the invention have been described. Nevertheless, it will be understood that various modifications may be made without departing from the spirit and scope of the invention. Accordingly, other embodiments are within the scope of the invention.

For example, other embodiments of the invention may include English as a second language version of the online reading system localized into foreign languages (e.g., Chinese, Spanish, Korean, etc.). In addition, other embodiments may include advanced reading skills, such as a program that takes children to beyond a basic reading level (e.g., elementary school, high school, college, etc.). In addition, other embodiments may include specific reading comprehension programs. In addition, other embodiments may include a mathematics program (such as addition, subtraction, multiplication, division, etc.). In addition, other embodiments may include an advanced mathematics program (such as basic algebra and geometry).

We claim:

1. A language tutorial reading system, comprising:
a computer-implemented teaching module comprising a tutorial subsystem and a games system, wherein the teaching module delivers a plurality of content modules and automatically corrects errors committed by students and causes the play of audio tracks corresponding to words being taught to a student and wherein the teaching module requires students to enter input in a left-to-right sequence;
a computer-implemented assessment module to deliver skills surveys and provide feedback, wherein the assessment module causes the teaching module to skip content modules where skills surveys indicate that students have achieved predetermine objective scoring thresholds;
a computer-implemented customization module to manage user profiles and statistics;
a computer-implemented language module to manage a words database and problems module; and
a computer-implemented books module to serve books comprising words and problems from the language module.
